(19) United States
(12) Patent Application Publication
(10) Pub. No.: US 2011/0091123 A1
(43) Pub. Date: Apr. 21, 2011

(54) Coding apparatus and coding method

(75) Inventors: Takahiro Fukuhara, Kanagawa (JP); Katsutoshi Ando, Kanagawa (JP); Koji Hara, Kanagawa (JP)

(73) Assignee: Sony Corporation, Tokyo (JP)

(21) Appl. No.: 12/924,780

(22) Filed: Oct. 5, 2010

(30) Foreign Application Priority Data
Oct. 21, 2009 (JP) P2009-242769

(51) Int. Cl. G06K 9/36

(52) U.S. Cl. 382/248

(57) ABSTRACT

A coding apparatus includes: a wavelet transform section which transforms image data into coefficient data for every sub-band; a code blocking section which divides a region of the sub-band of the coefficient data generated by the wavelet transform section into code blocks; a state transition section which transits a state of the coefficient data which is a process target according to the value and state of surrounding binary coefficient data adjacent to the coefficient data which is the process target; a selection section which selects a coding pass according to the state of the coefficient data transited by the state transition section; and a coding section which codes the coefficient data for every code block generated by the code blocking section according to the coding pass selected by the selection section.

### BACKGROUND OF THE INVENTION

1. Field of the Invention

The present invention relates to a coding apparatus and a coding method, and more particularly, to a coding apparatus and a coding method which can perform coding at a high speed.

2. Description of the Related Art

JPEG (Joint Photographic Experts Group) 2000, standardized by ISO/IEC (International Organization for Standardization/International Electrotechnical Commission) in 2000, is an image coding system having a variety of functions including a high compression ratio, lossless and lossy compression, scalability (resolution, image quality and the like), error tolerance and so on, which is highly expected to become an alternative technique to JPEG.

In 2004, JPEG2000 Part-1 was selected as a standard codec according to DCI (Digital Cinema Initiative). Accordingly, image photography, image editing and image delivery of digital cinema can be all integrated under JPEG2000.

Further, medical images, satellite photograph images or the like should necessarily be stored in their original state. Currently, there have been a variety of digital single lens reflex cameras which can store raw data or RGB data acquired by an image sensor such as CCD (Charge Coupled Device) or CMOS (Complementary Metal Oxide Semiconductor) in a non-compressed state on a memory card.

However, the non-compression of master images is advantageous in that loss of image data can be prevented, but is disadvantageous in that the data size becomes large. For this reason, the expectation of compression and decompression according to the JPEG2000 lossless compression is growing these days, for example, in uses where image quality is considered important, as described above, in addition to digital cinema.

Japanese Patent No. 3,906,630 discloses an image coding apparatus which includes both a fixed-point type wavelet transformer and an integer type wavelet transformer, which can perform both a lossless transform and a lossy transform and can increase the degree of freedom in the selection of image quality and compression ratio.

### SUMMARY OF THE INVENTION

However, JPEG2000 may be problematic in that its calculation load is remarkably larger than JPEG, and in particular, in that all coefficient data is compressed without loss in the case of lossless compression, which causes extensive time.

In such a JPEG2000 technique for coding, an entropy coding section referred to as EBCOT (Embedded Block Coding with Optimized Truncation) has the largest calculation load. This EBCOT employs a technique which arithmetically codes binary data being expanded in bit-planes while modeling the binary data in the unit of one pixel. Thus, after sequential processing is performed, “dependence” occurs in which the result of an upper bit-plane affecting a result of a lower bit-plane, thereby making it difficult to parallelize the inside of code blocks. Therefore, in the case of coding and lossless compression for an image having a high level of resolution, how to realize high-speed processing of the calculation load of JPEG2000, in particular, EBCOT has been a key issue.

Accordingly, it is desirable to provide a coding apparatus and a coding method which is capable of performing coding at a high speed.

According to an embodiment of the present invention, there is provided a coding apparatus including: wavelet transform means for transforming image data into coefficient data for every sub-band; code blocking means for dividing a region of the sub-band of the coefficient data generated by the wavelet transform means into code blocks; state transition means for transitioning the state of the coefficient data which is a process target according to the value and the state of surrounding binary coefficient data adjacent to the coefficient data which is the process target; selection means for selecting a coding pass according to the state of the coefficient data transited by the state transition means; and coding means for coding the coefficient data for every code block generated by the code blocking means according to the coding pass selected by the selection means.

The state of the coefficient data may be defined by four variables of a positive or negative sign (Sign), a first state variable (Status-0), a second state variable (Status-1) and significance (Sig) of a coefficient.

The state of the coefficient data may be obtained, on the basis of an information table indicating the correspondence relation between three variables of a first state variable (Status-0), a second state variable (Status-1) and significance (Sig), and seven states of the coefficient data, from values of the three variables.

A first state of the seven states may be a state where the coefficient data is coded by a CU pass, a second state thereof may be a state where the coefficient data becomes an invalid sample, a third state may be a state where a surrounding significant sample exists and the coefficient data is coded by the CU pass when the coefficient data is not coded in a current bit-plane, a fourth state may be a state where the surrounding significant sample exists and the coefficient data is coded by an SP pass, a fifth state may be a state where the coefficient data is significant and is already completely coded in the current bit-plane by the SP pass, a sixth state may be a state where the coefficient data is significant and is to be coded by an MR pass and the next MR pass is a first MR pass, and a seventh state may be a state where the coefficient data is significant and is to be coded by the MR pass and the next MR pass is a second MR pass.

The state transition means may transit the state of the coefficient data into the third state, in a case where the state of the coefficient data which is the process target is the first state and any one of the surrounding coefficient data become significant through the CU pass.

The state transition means may transit the state of the coefficient data into the fifth state, in a case where the coefficient data which is the process target is in the first state and become significant through the CU pass.

The state transition means may transit the state of the coefficient data into the fourth state, in a case where the coefficient data which is the process target is in the third state and is coded through the SP pass.

The state transition means may transit the state of the coefficient data into the fifth state, in a case where the coefficient data which is the process target is in the third state and become significant through the CU pass.

The state transition means may transit the state of the coefficient data into the sixth state, in a case where the coefficient data which is the process target is in the fifth state and the coding in one bit-plane is entirely terminated.

The state transition means may transit the state of the coefficient data into the seventh state, in a case where the coefficient data which is the process target is in the sixth state and the coding in one bit-plane is entirely terminated.

The coding apparatus may further include storage means for storing the state of each piece of coefficient data in a code block which is a process target, which is transited by the state transition means, and the selection means may select the coding pass according to the state of the coefficient data stored in the storage means.

The coding means may include: calculation means for performing a predetermined calculation for the coefficient data according to the coding pass selected by the selection means; and arithmetic coding means for performing an arithmetic coding using calculation results from the calculation means.

The calculation means may include: CU pass calculation means for performing a predetermined calculation for the coefficient data in a case where the CU pass is selected by the selection means; SP pass calculation means for performing a predetermined calculation for the coefficient data in a case where the SP pass is selected by the selection means; and MR pass calculation means for performing a predetermined calculation for the coefficient data in a case where the MR pass is selected by the selection means.

The CU pass calculation means may perform both of a calculation in which a result of a run length coding is zero and a calculation in which the result of the run length coding is one, for four pieces of coefficient data in the code block, and the arithmetic coding means may MQ-code the coefficient data of a value zero and the coefficient data of a value one, using a context of the run length coding.

The CU pass calculation means may perform a uniform coding two times, for four pieces of coefficient data in the code block, and the arithmetic coding means may MQ-code a coefficient zero or one for each of the two-time uniform codings, using a uniform context.

The CU pass calculation means may calculate whether or not to perform a CU coding for every coefficient data of the code block, and the arithmetic coding means may perform an MQ coding according to a result of the calculation, using a significance context.

The CU pass calculation means may calculate whether or not to perform a sign coding for every coefficient data of the code block, and the arithmetic coding means may perform an MQ coding according to a result of the calculation, using a sign context.

The SP pass calculation means may calculate whether or not the value of the coefficient data is one, and the arithmetic coding means may perform an MQ coding according to the result of the calculation, using a sign context.

The MR pass calculation means may calculate whether or not to perform an MR coding, and the arithmetic coding means may perform an MQ coding according to a result of the calculation, using an MR context.

According to an embodiment of the present invention, there is provided a coding method including the steps of: transforming image data into coefficient data for every sub-band; dividing a region of the sub-band of the transformed coefficient data into code blocks; transitioning a state of the coefficient data which is a process target according to a value and a state of surrounding binary coefficient data adjacent to the coefficient data which is the process target, for each divided code block; selecting a coding pass according to the transited state of the coefficient data; and coding the coefficient data for each generated code block according to the selected coding pass.

According to an embodiment of the present invention, image data is transformed into coefficient data for every sub-band; a region of the sub-band of the transformed coefficient data is divided into code blocks; a state of the coefficient data which is a process target is transited according to a value and a state of surrounding binary coefficient data adjacent to the coefficient data which is the process target, for each divided code block; a coding pass is selected according to the transited state of the coefficient data; and the coefficient data is coded for each generated code block according to the selected coding pass.

According to the embodiments, it is possible to code the image, in particularly, to code the image at a high speed.

### BRIEF DESCRIPTION OF THE DRAWINGS

FIG. 1 is a block diagram illustrating an example of a main configuration of an image coding apparatus according to embodiment of the present invention.

FIG. 2 is a diagram illustrating an example of a configuration of sub-bands.

FIG. 3 is a diagram illustrating an example of code blocks in respective sub-bands.

FIG. 4 is a diagram illustrating an example of bit-planes.

FIG. 5 is a diagram illustrating an example of coding passes.

FIG. 6 is a diagram illustrating an example of scanning of coefficients.

FIG. 7 is a diagram illustrating an example of definitions of states.

FIG. 8 is a diagram illustrating an example of a state transition table.

FIG. 9 is a flowchart illustrating an example of a flow of a coding process.

FIG. 10 is a flowchart illustrating an example of a flow of an EBCOT process.

FIG. 11 is a flowchart illustrating an example of a flow of a CU pass process.

FIG. 12 is a flowchart illustrating an example of a flow of the CU pass process, which follows on from FIG. 11.

FIG. 13 is a flowchart illustrating an example of a process in which an actual operation of a CU pass process is generated.

FIG. 14 is a flowchart illustrating another example of a process in which an actual operation of a CU pass process is generated.

FIG. 15 is a flowchart illustrating still another example of a process in which an actual operation of a CU pass process is generated.

FIG. 16 is a flowchart illustrating an example of a flow of a CU pass process in the related art.

FIG. 17 is a flowchart illustrating an example of a flow of an SP pass process.

FIG. 18 is a flowchart illustrating an example of a flow of an SP pass process in the related art.

FIG. 19 is a flowchart illustrating an example of a flow of an MR pass process.

FIG. 20 is a flowchart illustrating an example of a flow of an MR pass process in the related art.

FIG. 21 is a block diagram illustrating another configuration example of an image coding apparatus according to an embodiment of the present invention.

FIG. 22 is a diagram illustrating a coding pass.

FIGS. 23A, 23B and 23C are diagrams illustrating grouping of code blocks.

FIG. 24 is a diagram illustrating generation of parallel arithmetic coefficient data.

FIG. 25 is a diagram illustrating parallel arithmetic of coefficient data.

FIG. 26 is a flowchart illustrating another example of a flow of a coding process.

FIG. 27 is a diagram illustrating an example of hardware according to an embodiment of the present invention.

FIG. 28 is a block diagram illustrating an example of a configuration of a personal computer according to an embodiment of the present invention.

### DESCRIPTION OF THE PREFERRED EMBODIMENTS

Hereinafter, preferred embodiments for carrying out the present invention will be described in the following order.

1. First embodiment (image coding apparatus)

2. Second embodiment (image coding apparatus)

3. Third embodiment (personal computer)

### 1. First Embodiment

### Configuration of Image Coding Apparatus

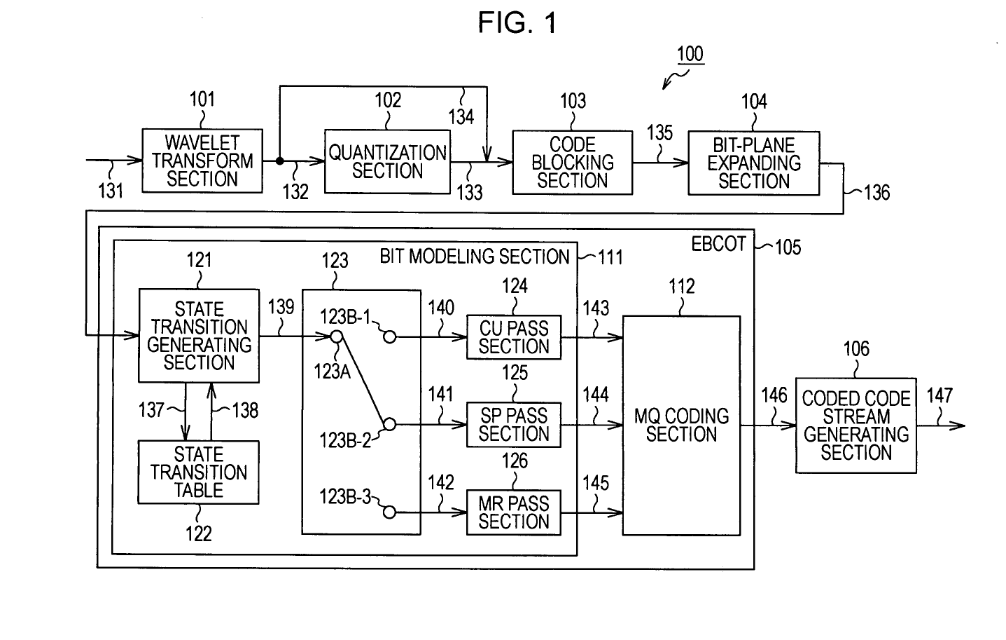

FIG. 1 is a diagram illustrating a configuration of an image coding apparatus according to of an embodiment of the present invention. An image coding apparatus 100 in FIG. 1 performs lossless or lossy coding to image data according to the JPEG (Joint Photographic Experts Group) 2000 system.

The image coding apparatus 100 wavelet-transforms the image data, expands obtained coefficients into a bit-plane for each code block, and performs entropy coding for each bit-plane.

The image coding apparatus 100 performs entropy coding called EBCOT (Embedded Block Coding with Optimized Truncation) specifically determined in the JPEG2000 standard (reference document: ISO/IEC 15444-1, Information technology-JPEG2000, Part 1: Core coding system).

The entropy coding called EBCOT is a technique which arithmetically codes binary data being expanded in bit-planes while modeling the binary data in the unit of one pixel.

In the related art, in this process, since “dependence” occurs in which a result of an upper bit-plane affects a result of a lower bit-plane after sequential processing is performed, it is difficult to parallelize the inside of code blocks. Therefore, in the case of coding and lossless compression for an image having a high level of resolution, how to realize high-speed processing of the calculation load in JPEG2000, in particular, EBCOT has been a key issue.

Thus, the image coding apparatus 100 performs MQ coding (arithmetic coding) regardless of the bit modeling result in EBCOT, to thereby realize deletion of conditional branches in coding passes. More specifically, the image coding apparatus 100 newly defines the transitions of states of coefficients in code blocks, to thereby delete an unnecessary conditional branch which is a bottleneck to processing speed in the related art. Accordingly, the image coding apparatus 100 can realize high-speed processing of EBCOT, that is, reduction in the calculation load in JPEG2000.

As shown in FIG. 1, the image coding apparatus 100 includes a wavelet transform section 101, a quantization section 102, a code blocking section 103, a bit-plane expanding section 104, an EBCOT 105 and a coded code stream generating section 106.

The wavelet transform section 101 is typically realized by a filter bank including a low-pass filter and a high-pass filter. Further, since a digital filter generally has an impulse response (filter coefficient) having a length of a plurality of taps, the wavelet transform section 101 has a buffer for buffering in advance only the amount of an input image that is to be filtered.

The wavelet transform section 101 obtains input image data (arrow 131) by a minimum data amount necessary for filtering or more. The wavelet transform section 101 filters the image data, for example, using a 5×3 wavelet transform filter to generate wavelet coefficients. The wavelet transform section 101 performs filtering so that the image data is separated into a low-frequency component and a high-frequency component in the respective vertical and horizontal directions of the image.

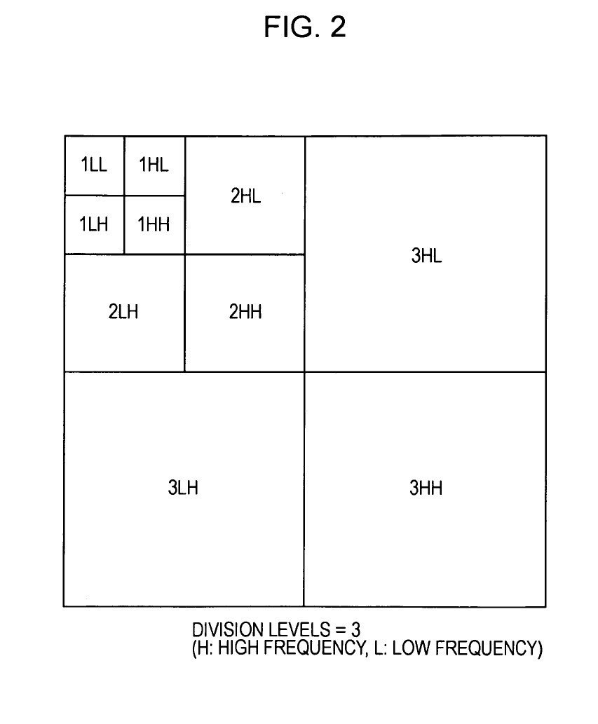

Further, the wavelet transform section 101 recursively repeats such a filtering process for sub-bands separated as the low-frequency component in both the vertical direction and the horizontal direction a predetermined number of times, as shown in FIG. 2. This considers the fact that most image energy concentrates on the low-frequency component.

FIG. 2 is a diagram illustrating an example of a configuration of sub-bands generated by a wavelet transform process with three division levels. In this case, firstly, the wavelet transform section 101 filters the entire image to generate sub-bands 3LL (not shown), 3HL, 3LH, and 3HH. Next, the wavelet transform section 101 filters the generated sub-band 3LL to generate sub-bands 2LL (not shown), 2HL, 2LH, and 2HH. Then, the wavelet transform section 101 filters the generated sub-band 2LL to generate sub-bands 1LL, 1HL, 1LH, and 1HH.

The number of the division levels of the wavelet transform is arbitrary.

Returning to FIG. 1, the wavelet transform section 101 supplies the coefficient data (wavelet coefficients) obtained by the filtering for each sub-band to the quantization section 102 (arrow 132).

The quantization section 102 quantizes the supplied coefficient data (wavelet coefficients). The quantization section 102 supplies the obtained coefficient data (quantized coefficients) to the code blocking section 103 (arrow 133). In the JPEG2000 standard, the quantization process is omitted in the case of lossless compression. In this case, the coefficient data (wavelet coefficients) output from the wavelet transform section 101 is supplied to the code blocking section 103 (arrow 134).

The code blocking section 103 divides the supplied coefficient data of each bit-plane into rectangular code blocks of a predetermined size, which are processing units of entropy coding. According to the definition of the JPEG2000 standard, the vertical and horizontal sizes of the code blocks are uniform in any sub-band. Here, on opposite ends of the image (sub-band) or upper and lower ends thereof or the like, code blocks having the same size may not be obtained.

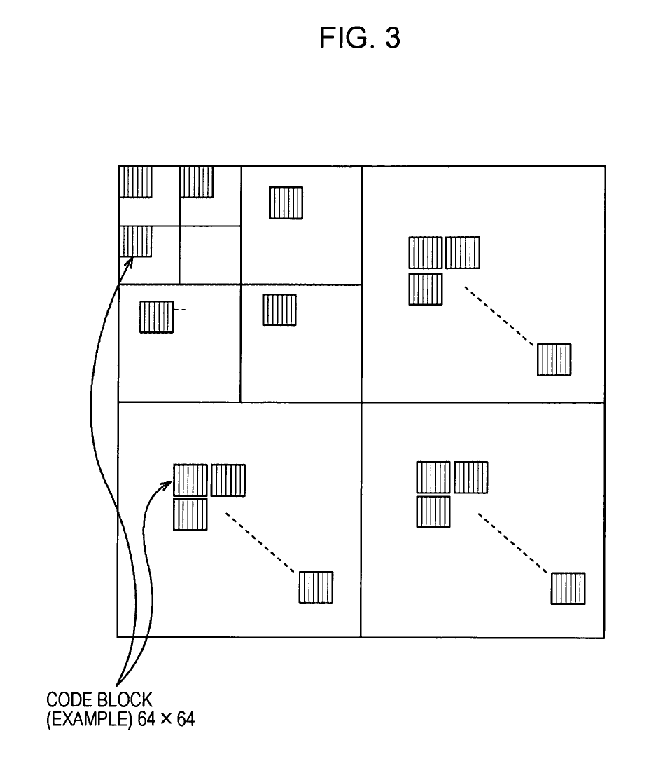

FIG. 3 illustrates the positional relationship of code blocks in each sub-band as described with reference to FIG. 2. Code blocks of a size of about 64×64 pixels, for example, are generated in all the sub-bands after the division. For example, supposing that the sub-band 3HH at the lowest division level has a size of 640×320 pixels, for example, the sub-band 3HH includes a total of 50 code blocks of 64×64 pixels. Each processing section in the following stages performs processing for each of the code blocks. Of course, the size (number of pixels) of the code blocks is arbitrary.

Returning to FIG. 1, the code blocking section 103 supplies the coefficient data to the bit-plane expanding section 104, for every code block (arrow 135).

The bit-plane expanding section 104 expands the supplied coefficient data for every code block into a bit-plane in each bit position.

The bit-plane is obtained by dividing (slicing) a coefficient group (for example, code blocks to be described later) of a predetermined number of wavelet coefficients for each bit, that is, in each position. That is, the bit-plane is a set of bits (coefficient bits), in the same position, of a plurality of pieces of data each having a bit depth of a plurality of bits. Accordingly, the number of the expanded bit-planes depends on the bit depth of each coefficient.

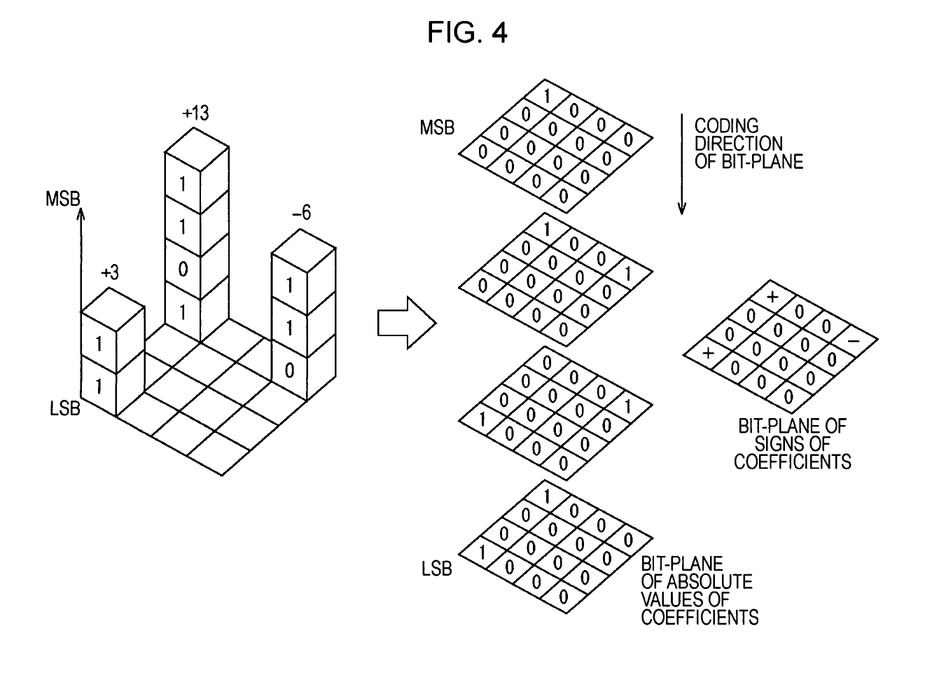

FIG. 4 shows a specific example of the bit-planes. A left diagram in FIG. 4 shows a total of 16 coefficients with four coefficients in the vertical direction and four coefficients in the horizontal direction. Among the 16 coefficients, the coefficient having the maximum absolute value is 13, which is represented as 1101 in binary notation. The bit-plane expanding section 104 expands such a coefficient group into four bit-planes showing absolute values (bit-planes of absolute values) and one bit-plane showing signs (a bit-plane of signs). That is, the coefficient group on the left side in FIG. 4 is expanded into the four absolute value bit-planes and the one sign bit-plane, as shown on the right side in FIG. 4. All elements of the absolute value bit-planes assume a value of 0 or 1. Further, elements of the bit-plane displaying signs assume one of a value indicating that the value of the coefficient is a positive value, a value indicating that the value of the coefficient is 0, and a value indicating that the value of the coefficient is a negative value.

The number of the coefficients in the coefficient group thus converted into the bit-planes is arbitrary. Hereinafter, the description will be made supposing that the bit-plane expanding section 104 expands coefficients into bit-planes for each code block, so as to facilitate processing in each section by integrating processing units.

Returning to FIG. 1, the bit-plane expanding section 104 supplies the EBCOT 105 with the expanded bit-planes, in order from a most significant bit (MSB) of the coefficients to a least significant bit (LSB) thereof. That is, the bit-plane expanding section 104 supplies the EBCOT 105 with the expanded bit-planes in order from a higher level side to a lower level side of the bit depth (arrow 136).

The EBCOT 105 performs coding for each block of a predetermined size while measuring statistics of coefficients within the block. The EBCOT 105 performs entropy coding for the quantized coefficients in the code block unit. Each code block is independently coded for each bit-plane from the most significant bit (MSB) to the least significant bit (LSB). The vertical and horizontal sizes of the code blocks are powers of ranging from 4 to 256, and sizes generally used include 32×32, 64×64, 128×32 and the like. Suppose that a quantized coefficient value is represented by an n-bit binary number with a sign, and that bits of zero to n−1 represent respective bits from the LSB to the MSB. The one remaining bit indicates the sign. The code blocks are coded by the following three types of coding passes in order from the bit-plane on the MSB side.

(1) Significant Propagation Pass

(2) Magnitude Refinement Pass

(3) Cleanup Pass

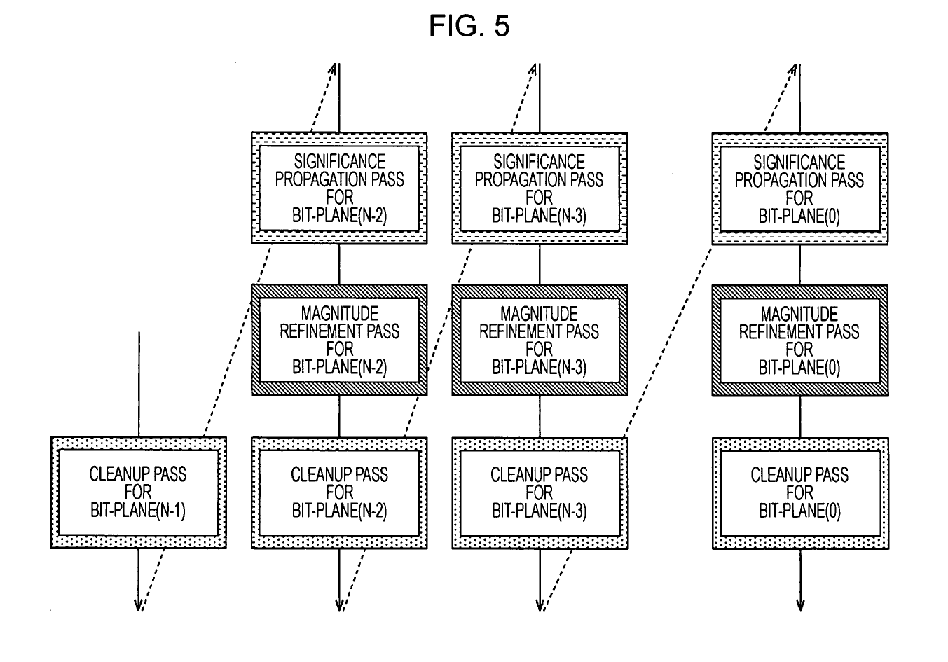

The order in which the three types of coding passes are used is shown in FIG. 5. Firstly, a bit-plane (n−1) (MSB) is coded by Cleanup Pass. Then, each bit-plane is sequentially coded toward the LSB side using the three coding passes in the order of Significant Propagation Pass, Magnitude Refinement Pass and Cleanup Pass.

However, in reality, the EBCOT 105 writes in what number bit-plane from the MSB side one first appears in the header, and does not code bit-planes whose coefficients are all zero and which continue from the MSB side (which will be referred to as zero bit-planes). The coding is performed repeatedly using the three types of coding passes in the above order, and is terminated in an arbitrary coding pass of an arbitrary bit-plane, to thereby acquire trade-off between code amount and image quality (performing a rate control).

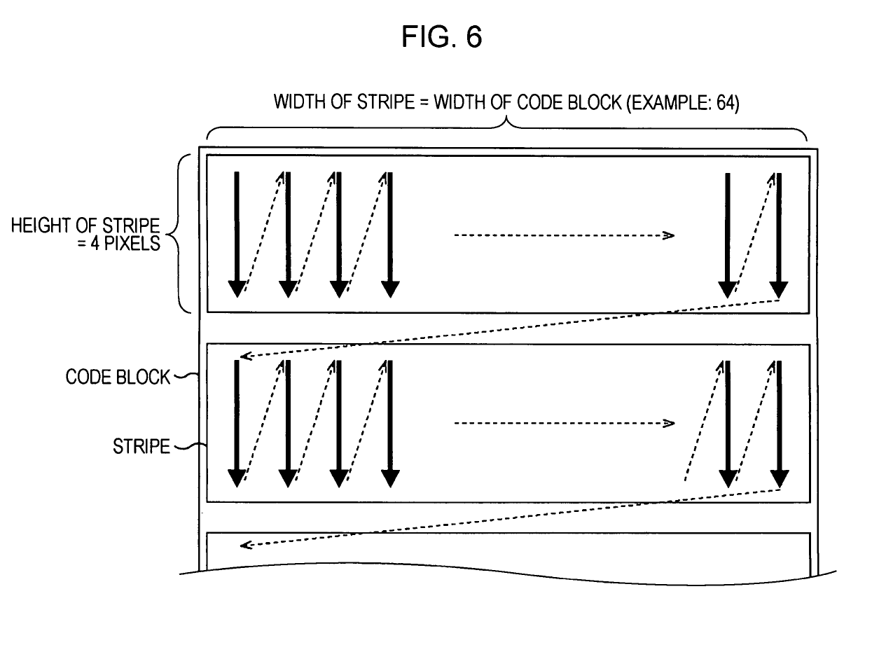

Next, the scanning of coefficients will be described with reference to FIG. 6. A code block is divided into stripes each having a height of four coefficients. The width of the stripe is equal to the width of the code block. A scan order is an order in which all coefficients within one code block are traced, and is an order from an upper stripe to a lower stripe in the code block, and an order from a left column to a right column in a stripe, and an order from a top to a bottom in a column. All the coefficients in the code block are processed in this scan order in each coding pass.

Hereinafter, the three types of coding passes will be described, which are disclosed in JPEG-2000 standard (reference document: ISO/IEC 15444-1, Information technology-JPEG2000, Part 1: Core coding system).

### (1) Significance Propagation Pass (SP Pass)

In Significant Propagation Pass for coding a certain bit-plane, values in the bit-plane of such non-significant coefficients that at least one of 8-neighbor coefficients is significant are subjected to arithmetic coding. When the coded value of the bit-plane is one, information indicating whether a sign is positive or negative is subsequently subjected to the MQ coding.

The word “significance” which is a special term in JPEG2000 will be described. The significance refers to the state of an encoder for each coefficient, in which an initial value of the significance is zero indicating “non-significant”, the value is changed to one indicating “significant” when one is coded in the concerned coefficient, and then the value is continued as one. Accordingly, the significance can be also referred to as a flag indicating whether information on valid digits has already been coded. When a coefficient becomes significant in a certain bit-plane, the coefficient remains significant in subsequent bit-planes.

### (2) Magnitude Refinement Pass (MR Pass)

In Magnitude Refinement Pass for coding the bit-plane, values in the bit-plane of significant coefficients not coded in Significance Propagation Pass for coding the bit-plane are subjected to the MQ coding.

### (3) Cleanup Pass (CU Pass)

In Cleanup Pass for coding the bit-plane, values in the bit-plane of non-significant coefficients not coded in Significance Pass for coding the bit-plane are subject to the MQ coding. When the coded value of the bit-plane is one, sign information indicating whether a sign is positive or negative is subsequently subjected to the MQ coding.

In the MQ coding in the above three coding passes, methods such as ZC (Zero Coding), RLC (Run-Length Coding), SC (Sign Coding) and MR (Magnitude Refinement) are used properly on a case-by-case basis. Here, the arithmetic coding referred to as the MQ coding is used in this case. The MQ coding is a learning type binary arithmetic code defined in JBIG2 (reference document: ISO/IEC FDIS14492, “Lossy/Lossless Coding of Bi-level Images”, March 2000).

As shown in FIG. 1, the EBCOT 105 includes a bit modeling section 111 which performs bit modeling, and an MQ coding section 112 which performs arithmetic coding.

The bit modeling section 111 includes a state transition generating section 121, a state transition table 122, a selecting section 123, a CU pass (Cleanup Pass) section 124, an SP pass (Significant Propagation Pass) section 125, and an MR pass (Magnitude Refinement Pass) section 126.

In the present embodiment, the transition of states of coefficients, which is necessary when bit modeling is performed in the bit modeling section 111, is efficiently performed, to thereby perform EBCOT at a high speed.

The bit modeling of the EBCOT has the following characteristics.

(1) Each coefficient of the code block necessarily has a “state”.

(2) The “state” defines by what coding pass and in what way the coefficient is coded.

(3) The “state” is transited according to surrounding coefficients or surrounding “states” during coding.

The bit modeling section 111 provides the following four parameters so as to define the “state” of each coefficient.

1. Positive or negative sign (Sign)

2. State variable 1 (Status-0)

3. State variable 2 (Status-1)

4. Significance (Sig)

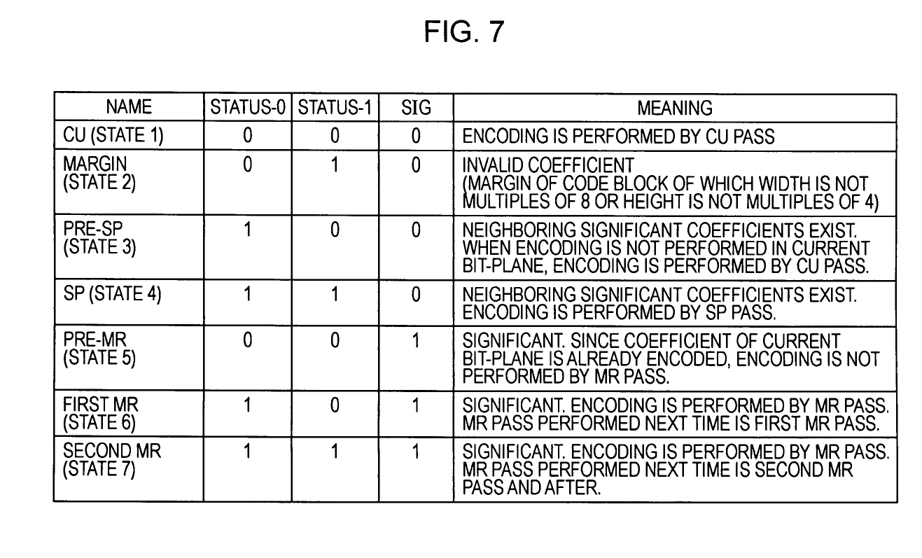

In this respect, the variable of the positive or negative sign may be omitted. FIG. 7 illustrates definitions of seven states for three variables excluding the positive or negative sign in the parameters (the positive or negative sign is unnecessary because a sign bit-plane indicating the positive or negative sign is independently coded, as shown in FIG. 4).

In the case of the related art EBCOT, only three passes of the CU pass, the SP pass and the MR pass exist, but the bit modeling section 111 also defines a state before transition to each coding pass. Each state has a meaning as represented in the table shown in FIG. 7.

State 1: Encoding is performed by the CU pass.

State 2: Invalid sample

State 3: Neighboring significant samples exist. When coding is not performed in a current bit-plane, the coding is performed by the CU pass.

State 4: Neighboring significant samples exist. Encoding is performed by the SP pass.

State 5: Significant. A current bit-plane is already completely coded by the SP pass.

State 6: Significant. Encoding is performed by the MR pass. The next MR pass is a first MR pass.

State 7: Significant. Encoding is performed by the MR pass. The next MR pass is a second MR pass.

The coding in the CU pass is basically the same as the case in the related art, but the SP pass is divided into two states of a pre-SP which is a stage before transition from the CU pass to the SP pass and a state in which the SP pass is performed. Further, the MR pass is divided into a pre-MR before the MR pass, in which the MR pass is not performed, and a first MR and a second MR in the first and second stages and after, during which the MR pass is performed. In this way, the bit modeling section 111 subdivides the three coding passes in the related art and then defines state transitions between respective states.

Returning to FIG. 1, the state transition generating section 121 makes use of the table to obtain states of coefficient data from values of the above described three variables.

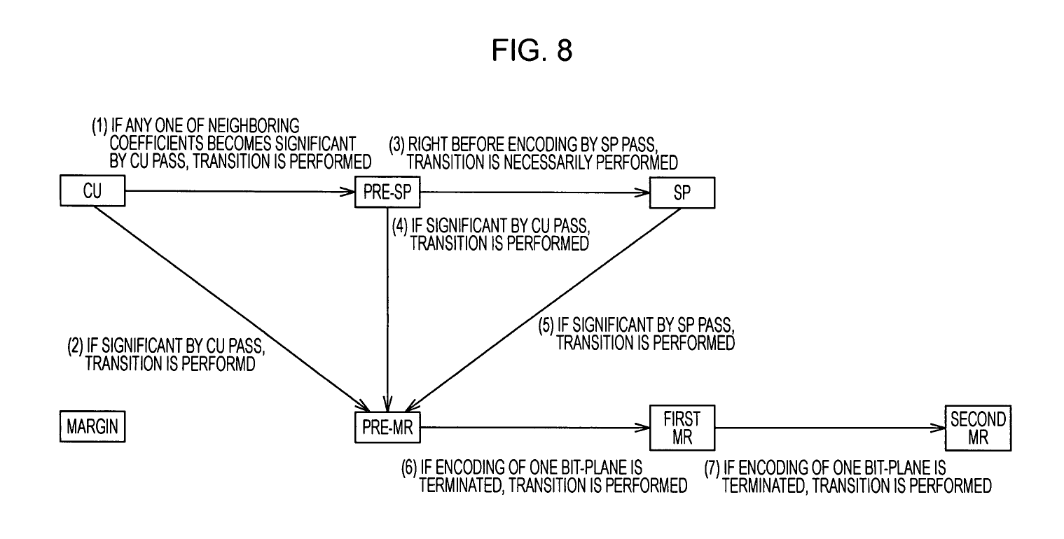

The state transition generating section 121 stores the state of each coefficient, and manages the transition of the state. For example, the state transition generating section 121 transits states of a coefficient which is a process target or surrounding coefficients, according to a variety of conditions such as a surrounding binary coefficient value which is adjacent to the process target coefficient, its state and the like, while referring to the state transition table 122 (arrows 137 and 138). The state transition conditions and the transition contents are defined in advance as the state transition table 122, for example, as shown in FIG. 8.

That is, the state transition is performed as follows.

(1) In a case where any one of surrounding coefficients becomes significant by the CU pass, the CU is transited to the pre-SP.

(2) In a case where the target coefficient becomes significant by the CU pass, the CU is transited to the pre-MR.

(3) Right before coding by the SP pass, the pre-SP is transited to the SP.

(4) In the case of becoming significant by the CU pass, the pre-SP is transited to the pre-MR.

(5) In the case of becoming significant by the SP pass, the SP is transited to the pre-MR.

(6) If coding of one bit-plane is terminated, the pre-MR is transited to the first MR.

(7) If coding of one bit-plane is terminated, the first MR is transited to the second MR.

Returning to FIG. 1, the state transition generating section 121 supplies information about the above-described state transition generation, the coefficient data and the like to the selecting section 123 (arrow 139).

The selecting section 123 selects one of terminals 123B-1 to 123B-3 as a connection target of a terminal 123A connected to the state transition generating section 121 according to the presence or absence of the state transition or its contents (the terminal 123A is connected to the selected terminal 1238).

The terminal 123B-1 is connected to the CU pass section 124, the terminal 123B-2 is connected to the SP pass section 125, and the terminal 123B-3 is connected to the MR pass section 126. That is, the selecting section 123 selects the connection target of the state transition generating section 121 from the CU pass section 124, the SP pass section 125 and the MR pass section 126. The coefficient data is supplied to the selected coding pass.

If the CU pass section 124 is supplied with the coefficient data or the like (arrow 140), the CU pass section 124 determines a context or label by the CU pass using the coefficient data or the like. The CU pass section 124 supplies information about the generated context, label or the like to the MQ coding section 112 (arrow 143).

If the SP pass section 125 is supplied with the coefficient data or the like (arrow 141), the SP pass section 125 determines a context or label by the CU pass using the coefficient data or the like. The SP pass section 125 supplies information about the generated context, label or the like to the MQ coding section 112 (arrow 144).

If the MR pass section 126 is supplied with the coefficient data or the like (arrow 142), the MR pass section 126 determines a context or label according to the MR pass using the coefficient data or the like. The MR pass section 126 supplies information about the generated context, label or the like to the MQ coding section 112 (arrow 145).

The MQ coding section 112 performs MQ coding on the basis of the information about the context, label or the like, supplied from the respective coding passes (the CU pass section 124, the SP pass section 125 and the MR pass section 126) of the bit modeling section 111. Here, the MQ coding section 112 performs the MQ coding regardless of the calculation result of each coding pass.

The MQ coding section 112 supplies the arithmetic coding result to the coded code stream generating section 106 (arrow 146).

The coded code stream generating section 106 aligns the coded data supplied from the EBCOT 105 (MQ coding section 112), and outputs the aligned coded data as one code stream (arrow 147).

### [Flow of Process]

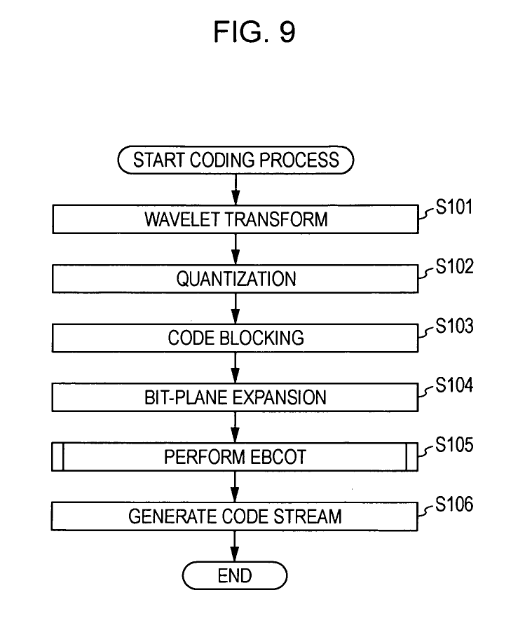

Next, an example of a flow of a coding process performed by the image coding apparatus 100 will be described with reference to a flowchart of FIG. 9.

If the coding process starts, the wavelet converting section 101 wavelet-transforms image data corresponding to one picture, in step S101. In step S102, the quantization section 102 quantizes coefficient data generated in step S101. In the case of lossless compression, the process of step S102 is omitted.

In step S103, the code blocking section 103 code-blocks the coefficient data. In step S104, the bit-plane expanding section 104 expands the coefficient data in bit-planes.

In step S105, the EBCOT 105 performs the EBCOT process, and codes the coefficient data.

In step S106, the coded code stream generating section 106 aligns the coded data generated in the EBCOT 105 to generate code streams and is output. If the process of step S106 is terminated, the coding process is terminated.

The coding process is performed for each picture.

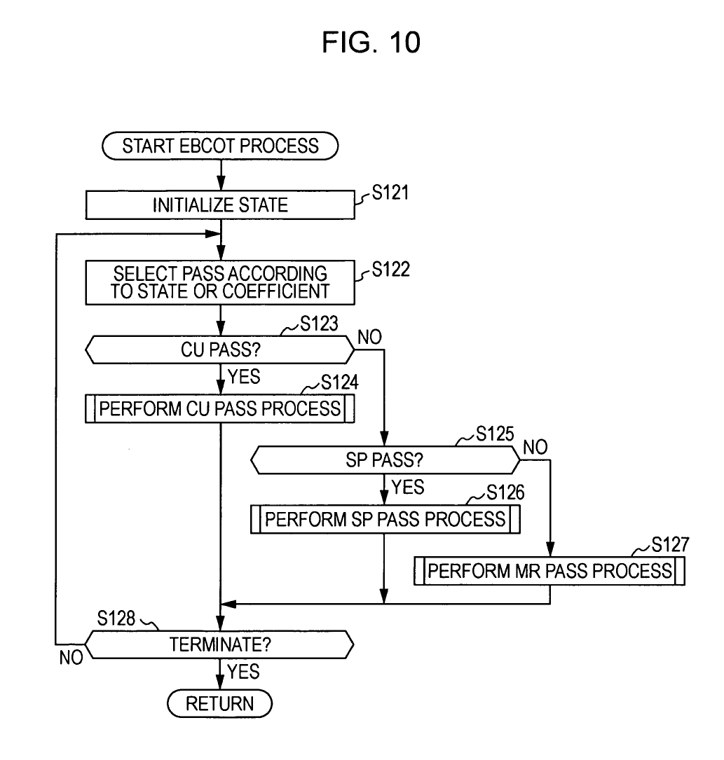

Next, the EBCOT process performed in step S105 in FIG. 9 will be described in detail with reference to a flowchart in FIG. 10.

If the EBCOT process starts, the state transition generating section 121 initializes states of coefficients of a code block in step S121. In step S122, the selecting section 123 selects a pass according to the state or coefficient. In step S123, the selecting section 123 determines whether or not the CU pass is selected.

If it is determined that the CU pass is selected, the procedure goes to step S124. In step S124, the CU pass section 124 and the MQ coding section 112 perform the CU pass process for performing coding by the CU pass. If the CU pass process is terminated, the procedure goes to step S128.

Further, in step S123, if it is determined that the CU pass is not selected, the procedure goes to step S125. In step S125, the selecting section 123 determines whether or not the SP pass is selected.

If it is determined that the SP pass is selected, the procedure goes to step S126. In step S126, the SP pass section 125 and the MQ coding section 112 perform the SP pass process for performing coding by the SP pass. If the SP pass process is terminated, the procedure goes to step S128.

Further, in step S125, if it is determined that the SP pass is not selected, the procedure goes to step S127. In step S127, the MR pass section 126 and the MQ coding section 112 perform the MR pass process for performing coding by the MR pass. If the MR pass process is terminated, the procedure goes to step S128.

In step S128, the EBCOT 105 determines whether or not to terminate the EBCOT process. If it is determined that unprocessed coefficient data exists and the EBCOT process is not to be terminated, the procedure returns to step S122, and the subsequent processes are repeated. Further, if it is determined in step S128 that all coefficient data in the picture is processed, the EBCOT process is terminated, and then the procedure returns to step S105 in FIG. 9, to thereby perform the processes of step S106 and thereafter.

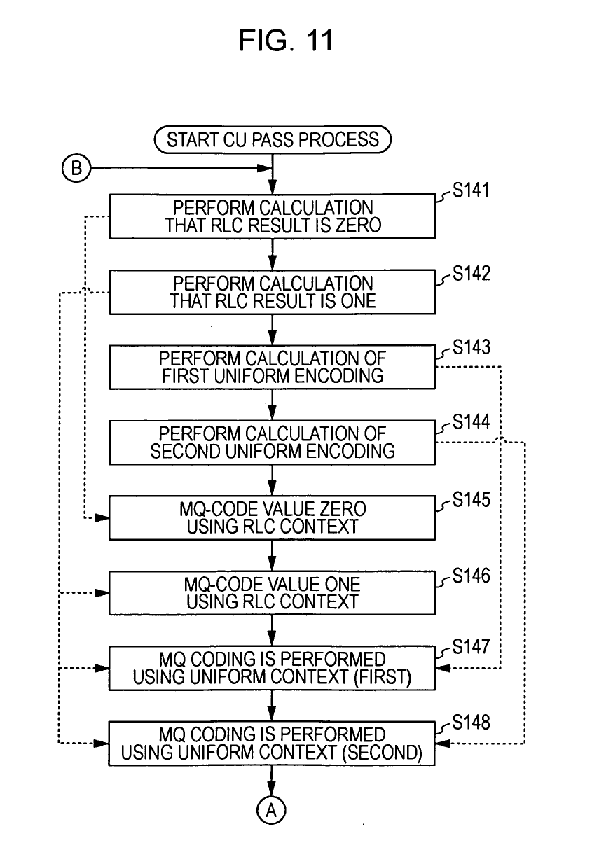

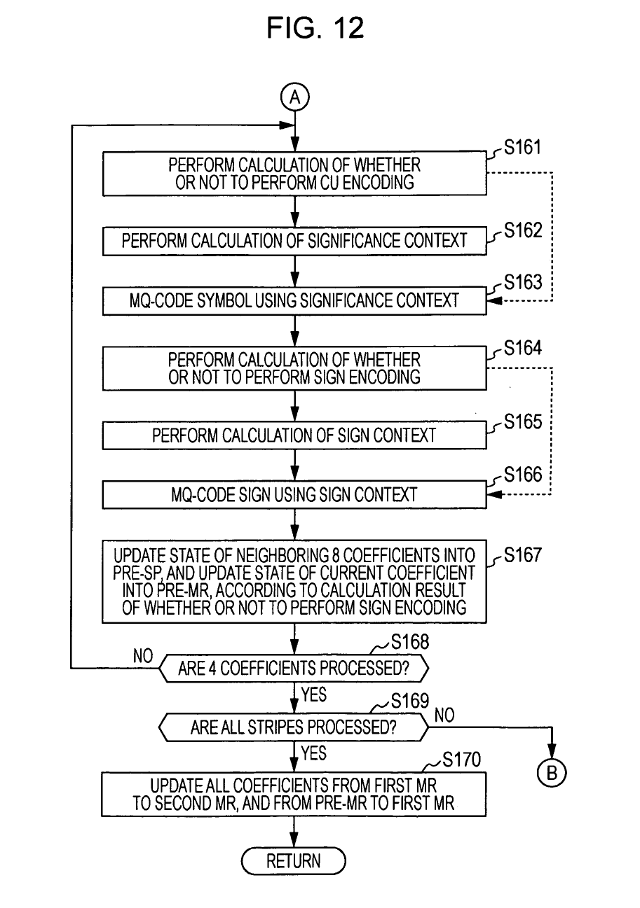

Next, an example of a flow of the CU pass process performed in step S124 in FIG. 10 will be described with reference to flowcharts in FIGS. 11 and 12. It is assumed that the horizontal size of the stripe is 64, and the vertical size thereof is 4. Further, in FIGS. 11 and 12, dashed arrows represent the dependence relation of data.

In the CU pass, while the coefficient group in the stripe in the vertical direction (4 coefficients in the case of the example in FIG. 6) is scanned from the top to the bottom direction, the following calculations (steps S141 to S148) are performed for the coefficient group (4 coefficients).

In step S141, the CU pass section 124 performs a calculation that the result of the run length coding (RLC: Run Length Coding) is zero. When the calculation succeeds, the calculation result becomes FF. Further, when the calculation fails, the calculation result becomes 00. These calculation results affect the process of step S145.

If the process of step S141 is terminated, the procedure goes to step S142. In step S142, the CU pass section 124 performs a calculation that the result of the RLC is one. When the calculation succeeds, the calculation result becomes FF. Further, when the calculation fails, the calculation result becomes 00. These calculation results affect the processes of steps S146 to S148.

If the process of step S142 is terminated, the procedure goes to step S143. In step S143, the CU pass section 124 performs a calculation of a first uniform coding. The coding target is zero or one. The calculation result affects the process of step S147.

If the process of step S143 is terminated, the procedure goes to step S144. In step S144, the CU pass section 124 performs a calculation of a second uniform coding. The coding target is zero or one. The calculation result affects the process of step S148.

In the CU pass process, there is an initial branch point of whether to perform the RLC process or not in step S141. Here, as shown in FIG. 11, in the present embodiment, the calculation that the RLC result is one and the calculation that the RLC result is zero are all performed. Further, using the result (FF or 00), the MQ coding section 112 can automatically determine whether the RLC is valid or not in reality.

If the process of step S144 is terminated, the procedure goes to step S145. The MQ coding section 112 MQ-codes the value zero using the RLC context in step S145, and MQ-codes the value one using the RLC context in step S146.

Further, the MQ coding section 112 performs a first MQ coding using the uniform context in step S147, and performs a second MQ coding using the uniform context in step S148.

If the process of step S148 in FIG. 11 is terminated, the procedure goes to step S161 in FIG. 12. In the CU pass, the following calculations (steps S161 to S167) are performed with respect to each coefficient in the above-described coefficient group (4 coefficients).

In step S161, the CU pass section 124 performs a calculation of whether or not to perform the CU coding. For example, when the CU coding is performed, the calculation result becomes FF, and when the CU coding is not performed, the calculation result becomes 00. The calculation results are used for the MQ coding in step S163.

If the process in step S161 is terminated, the procedure goes to step S162. In step S162, the CU pass section 124 performs a calculation of a significance context. In step S163, the MQ coding section 112 MQ-codes a symbol using the significance context.

If the process of step S163 is terminated, the procedure goes to step S164. In step S164, the CU pass section 124 performs a calculation of whether or not to perform a sign coding. For example, in a case where the sign coding is performed, the calculation result becomes FF, and in a case where the sign coding is not performed, the calculation result becomes 00. These calculation results are used for the MQ coding of step S166. Further, these calculation results are used for updating the states of step S167.

If the process of step S164 is terminated, the procedure goes to step S165. In step S165, the CU pass section 124 performs a calculation of a sign context. In step S166, the MQ coding section 112 MQ-codes a sign using a sign context.

In step S167, the state transition generating section 121 updates the states of the surrounding 8 coefficients into the pre-SP, and updates the state of the current coefficient into the pre-MR, on the basis of the calculation result of whether or not to perform the sign coding. Specifically, in a case where any of the surrounding 8 coefficients becomes one and the surrounding coefficients are rewritten into pre-SP, the current coefficient is transited from the CU to the pre-SP. Further, in a case where the current coefficient becomes one and is rewritten into the pre-MR, the current coefficient is transited from the CU to the pre-MR.

In step S168, the CU pass section 124 determines whether all coefficients in the coefficient group (4 coefficients) which is the process target are processed. If it is determined that an unprocessed coefficient exist, the procedure returns to step S161, and then repeats the subsequent processes.

Further, if it is determined in step S168 that all coefficients in the coefficient group (4 coefficients) which is the process target are processed, the procedure goes to step S169. In step S169, the CU pass section 124 determines whether all coefficients of all stripes of the bit-plane which is the process target are processed. If it is determined that an unprocessed coefficient exists, the procedure returns to step S141 in FIG. 11, and repeats the subsequent processes.

Further, if it is determined in step S169 in FIG. 12, that all coefficients are processed, the procedure goes to step S170. The CU pass process is necessarily performed at the end of one bit-plane, as shown in FIG. 5. Accordingly, in a final step S170 of the CU pass process, the state transition generating section 121 updates each state from the first MR to the second MR and from the pre-MR to the first MR, for all the coefficients.

If the process of step S170 is terminated, the CU pass is terminated, the procedure returns to step S124 in FIG. 10, and then the processes of step S128 and thereafter are performed.

In the above CU pass process, for example, the calculation that the RLC result is one is performed (step S142), and in a case where the sign output as the result is FF, this means that the calculation was valid. In this case, even though the calculation that the RLC result is zero is performed (step S141), it is obvious that the calculation result is 00 (invalid) (because the results zero and one are in the antinomy relation).

In addition, in a case where calculation that the RLC result is one is valid, the calculation of the uniform coding is performed two times. In any case, the coding target is zero or one. Further, there is a case where RLC is not performed at all, as a case other than the above two cases.

Hereinafter, with respect to three cases, the procedure of performing each process of steps S141 to S148 in FIG. 11 will be described.

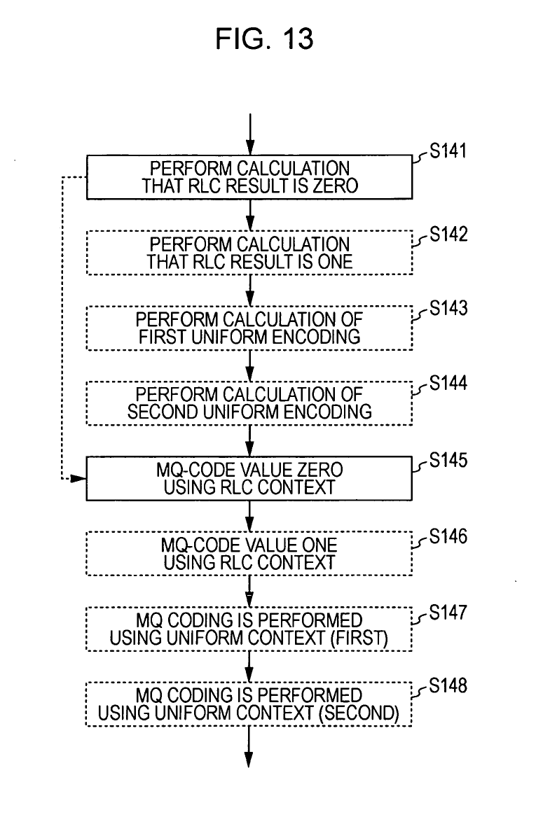

First of all, the process of actually generating an operation in a case where the RLC result is zero will be described with reference to FIG. 13.

<<Case 1 (case where the RLC result is zero)>>

(1) If the calculation that the RLC result is zero is performed (step S141), the result becomes FF.

(2) If the calculation that the RLC result is one is performed (step S142), the result becomes 00.

(3) Even though the calculation of the first uniform coding is performed (step S143), a code word is not generated.

(4) Even though the calculation of the second uniform coding is performed (step S144), the code word is not generated.

(5) The value zero is MQ-coded using the RLC context (step S145), and then the code word is output.

(6) Even though the value one is MQ-coded using the RLC context (step S146), the code word is not generated.

(7) Even though the MQ coding is performed using the (first) uniform context (step S147), the code word is not generated.

(8) Even though the MQ coding is performed using the (second) uniform context (step S148), the code word is not generated.

As described above, in the case where the RLC result is zero, each process of steps S141 to S148 is performed, but the process of actually generating the code word corresponds to only (5) (process of step S145).

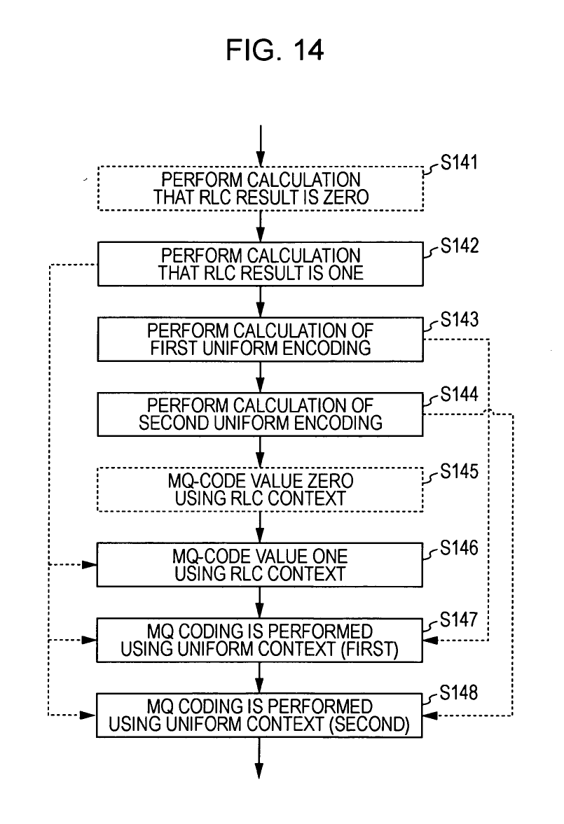

Next, the process of actually generating an operation in a case where the RLC result is one will be described with reference to FIG. 14.

<<Case 2 (case where the RLC result is one)>>

(1) If the calculation that the RLC result is zero is performed (step S141), the result becomes 00.

(2) If the calculation that the RLC result is one is performed (step S142), the result becomes FF.

(3) The calculation of the first uniform coding is performed (step S143), and then the code word is generated.

(4) The calculation of the second uniform coding is performed (step S144), and then the code word is generated.

(5) Even though the value zero is MQ-coded using the RLC context (step S145), the code word is not generated.

(6) The value one is MQ-coded using the RLC context (step S146), and then the code word is output.

(7) The MQ coding is performed using the (first) uniform context (step S147), and then the code word is output.

(8) The MQ coding is performed using the (second) uniform context (step S148), and then the code word is output.

As described above, in the case where the RLC result is one, each process of steps S141 to S148 is performed, but the process of actually generating the code word corresponds to (3) (step S143), (4) (step S144), (6) (step S146), (7) (step S147) and (8) (step S148).

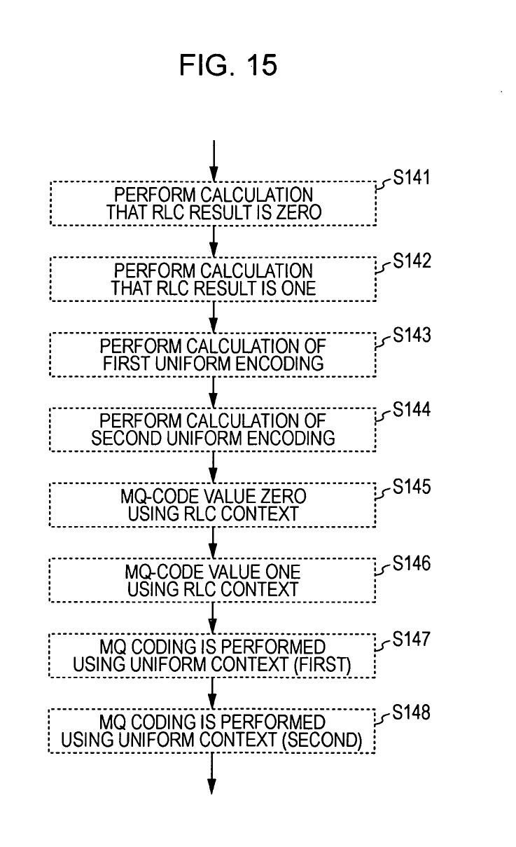

Next, the process of actually generating an operation in a case where the RLC is not performed will be described with reference to FIG. 15.

<<Case 3 (case where the RLC is not performed)>>

(1) If the calculation that the RLC result is zero is performed (step S141), the result becomes 00.

(2) If the calculation that the RLC result is one is performed (step S142), the result becomes 00.

(3) Even though the calculation of the first uniform coding is performed (step S143), the code word is not generated.

(4) Even though the calculation of the second uniform coding is performed (step S144), the code word is not generated.

(5) Even though the value zero is MQ-coded using the RLC context (step S145), the code word is not generated.

(6) Even though the value one is MQ-coded using the RLC context (step S146), the code word is not generated.

(7) Even though the MQ coding is performed using the (first) uniform context (step S147), the code word is not generated.

(8) Even though the MQ coding is performed using the (second) uniform context (step S148), the code word is not generated.

As described above, in the case where the RLC is not performed, each process of steps S141 to S148 is performed, but the process of actually generating the code word does not exist. This is the same as in the case where the RLC is not performed in the CU pass process in the related art, as will be described later.

In the above description, it is important that the MQ coding is performed regardless of the calculation result of the bit modeling, in the present embodiment. The MQ coding outputs an actually valid code word, for example, in a case where a certain calculation result is FF, but does not output the code word in a case where the calculation result is 00. The EBCOT 105 takes advantage of characteristics of the MQ coding, and thus, it is not necessary to perform condition determination.

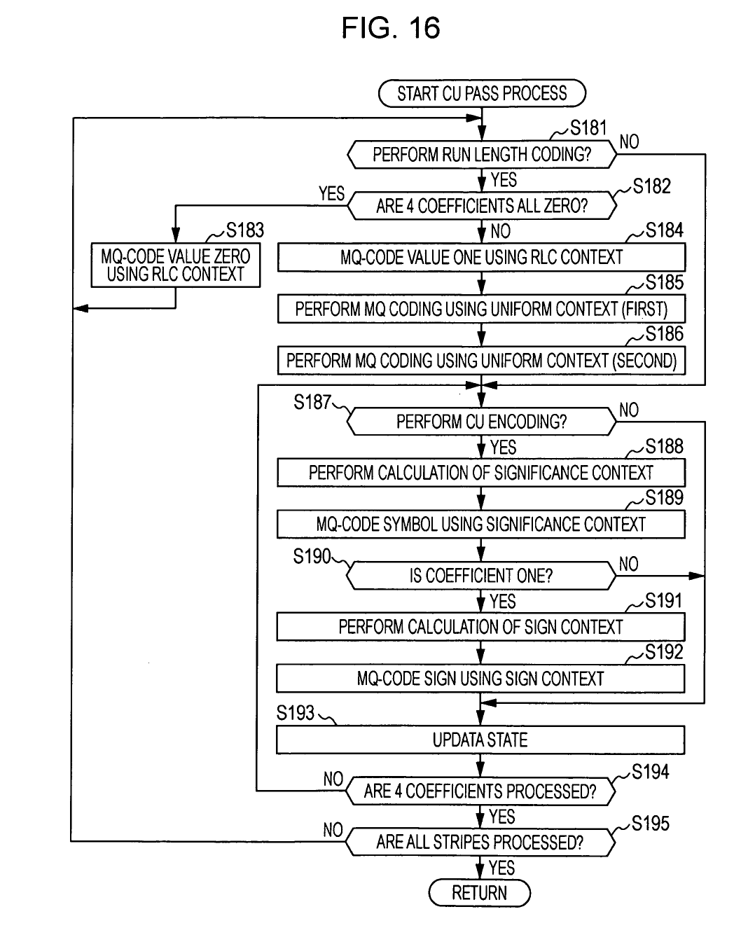

In this respect, a flow of the CU pass process in the related art is shown in a flowchart in FIG. 16.

That is, the process for the coefficient group (4 coefficients) in the stripe along the vertical direction is performed as shown in steps S181 to S186. Accordingly, a conditional branch occurs in two steps of whether or not to perform the RLC (step S181), and whether the 4 coefficients are all zero (step S182).

In a computer system, if the conditional branch (if then else) occurs, mishit of cache or penalty occurs, thereby causing rapid reduction in speed, which is well known. One important reason why the process load of the EBCOT of the JPEG2000 is heavy and thus high speed processing is difficult is that there are many conditional branches.

In this respect, as described above, the EBCOT 105 performs the processes (of step S141 to S148 in FIG. 11) for the coefficient group (4 coefficients) in the stripe in the vertical direction, without generating the conditional branch at all. Thus, the EBCOT 105 can perform coding at a high speed, compared with the method in the related art.

In other words, in the case of the method in the related art, in subsequent loop processes (steps s187 to S193 in FIG. 16) in the coefficient unit, there exist a conditional branch of whether or not to perform the CU coding (step S187) and a conditional branch of whether or not the coefficient is one (step S190). These two conditional branches are performed for each coefficient of the coefficient group (4 coefficients) in the stripe in the vertical direction. Accordingly, overhead due to these conditional branches becomes larger than overhead due to the conditional branches in the above-described steps S181 and S182.

In this respect, as described above, the EBCOT 105 does not generate the conditional branch at all in the processes (steps S161 to S167 in FIG. 12) for each coefficient. Thus, the EBCOT 105 can perform the coding at a high speed, compared with the method in the related art.

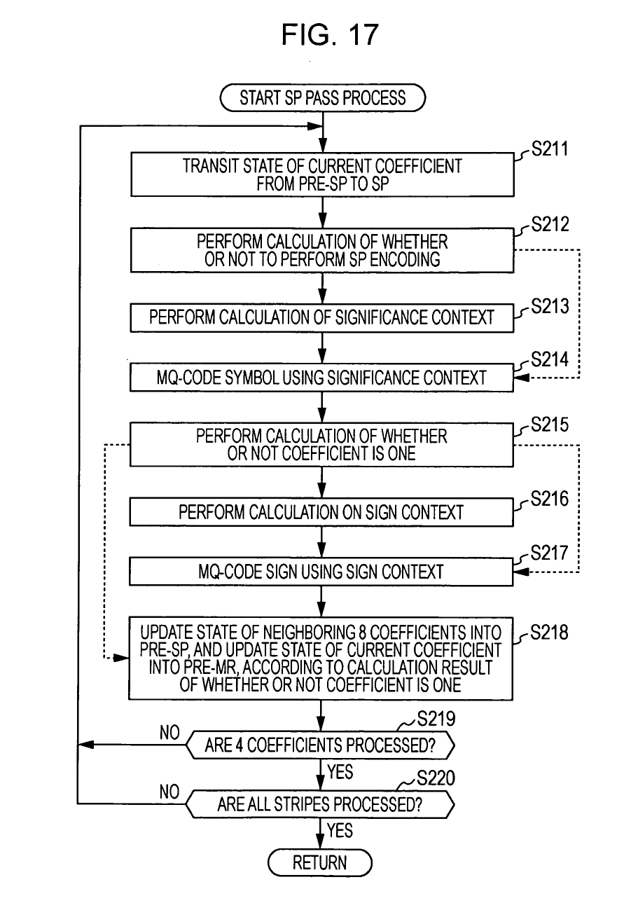

Next, an example of a flow of the SP pass process performed in step S126 in FIG. 10 will be described with a flowchart in FIG. 17. A dashed arrow represents the dependence relation of data.

If the SP pass process starts, in step S211, the state transition generating section 121 transits the state of a current coefficient from the pre-SP to the SP. In step S212, the SP pass section 125 performs a calculation of whether or not to perform the SP coding. For example, in a case where the SP coding is performed, the calculation result becomes FF, and in a case where the SP ecoding is not performed, the calculation result becomes 00. The calculation results are used for the MQ coding in step S214.

If the process of step S212 is terminated, the procedure goes to step S213. In step S213, the SP pass section 125 performs a calculation of a significance context. In step S214, the MQ coding section 112 MQ-codes a symbol using the significance context.

If the process of step S214 is terminated, the procedure goes to step S215. In step S215, the SP pass section 125 performs a calculation of whether or not the coefficient is one. For example, in a case where the coefficient is one, the calculation result becomes FF, and in a case where the coefficient is zero, the calculation result becomes 00. The calculation results are used for the MQ coding in step S217. Further, the calculation results are used for the state updating in step S218.

If the process of step S215 is terminated, the procedure goes to step S216. In step S216, the SP pass section 125 performs a calculation of a sign context. In step S217, the MQ coding section 112 MQ-codes a sign using the sign context.

In step S218, the state transition generating section 121 updates the states of the surrounding 8 coefficients into the pre-SP, and updates the state of the current coefficient into the pre-MR, on the basis of the calculation result of whether or not the coefficient is one. Specifically, in a case where any of the surrounding 8 coefficients becomes one and the surrounding coefficients are rewritten into pre-SP, the current coefficient is transited from the CU to the pre-SP. Further, in a case where the current coefficient becomes one and is rewritten into the pre-MR, the current coefficient is transited from the CU to the pre-MR.

In step S219, the SP pass section 125 determines whether all coefficients in the coefficient group (4 coefficients) which is the process target are processed. If it is determined that an unprocessed coefficient exists, the procedure returns to step S211, and repeats the subsequent processes.

Further, if it is determined in step S219 that all coefficients in the coefficient group (4 coefficients) which is the process target are processed, the procedure goes to step S220. In step S220, the SP pass section 125 determines whether all coefficients of all stripes in a bit-plane which is a process target are processed. If it is determined that an unprocessed coefficient exists, the procedure returns to step S211, and repeats the subsequent processes.

Further, in step S220, if it is determined that all coefficients are processed, the SP pass process is terminated. Then, the procedure returns to step S126 in FIG. 10, and the processes of step S128 and thereafter are performed.

In the case of the SP pass process, in a similar way to the case of the CU pass, the MQ coding is performed regardless of the calculation result of the bit modeling. The EBCOT 105 takes advantage of characteristics of the MQ coding, and thus, it is also unnecessary to perform condition determination in the SP pass process.

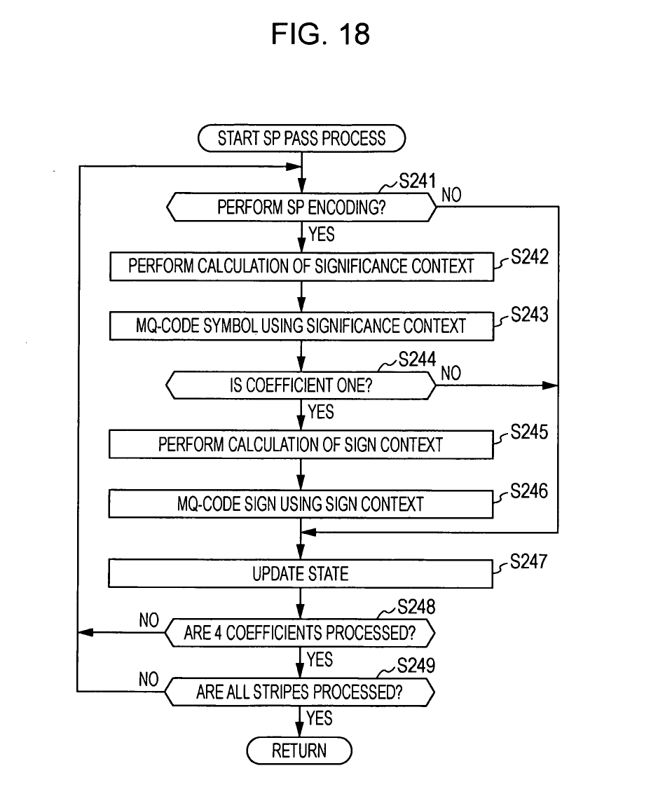

In this respect, a flow of the SP pass process in the related art is shown in a flowchart in FIG. 18.

That is, there exist a conditional branch of whether or not to perform the SP coding (step S241), and a conditional branch of whether or not the coefficient is one (step S244). These two conditional branches are performed for each coefficient of the coefficient group (4 coefficients) in the stripe in the vertical direction. Accordingly, the speed is likely to be significantly reduced due to overhead by these conditional branches.

In this respect, as described above, the EBCOT 105 does not generate any conditional branches at all in the processes (steps S211 to S218 in FIG. 17) for each coefficient. Thus, the EBCOT 105 can perform the coding at a high speed, compared with the method in the related art.

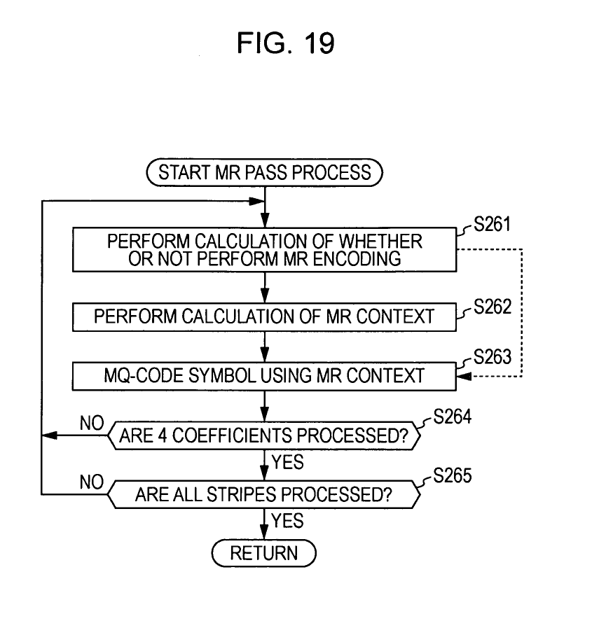

Next, an example of a flow of the MR pass process performed in step S127 in FIG. 10 will be described with a flowchart in FIG. 19. A dashed arrow represents the dependence relation of data.

If the MR pass process starts, in step S261, the MR pass section 126 performs a calculation of whether or not to perform the MR coding. For example, in a case where the MR coding is performed, the calculation result becomes FF, and in a case where the MR coding is not performed, the calculation result becomes 00. The calculation results are used for the MQ coding of step S263.

If the process of step S261 is terminated, the procedure goes to step S262. In step S262, the MQ pass section 126 performs a calculation of an MR context. In step S263, the MQ coding section 112 MQ-codes a symbol using the MR context.

If the process of step S263 is terminated, the procedure goes to step S264. In step S264, the MR pass section 126 determines whether all coefficients in the coefficient group (4 coefficients) which is the process target are processed. If it is determined that an unprocessed coefficient exists, the procedure returns to step S261, and then repeats the subsequent processes.

If it is determined in step S264 that all coefficients in the coefficient group (4 coefficients) which is the process target are processed, the procedure goes to step S265. In step S265, the MR pass section 126 determines whether all coefficients of all stripes in a bit-plane which is the process target are processed. If it is determined that an unprocessed coefficient exists, the procedure returns to step S261, and then repeats the subsequent processes.

Further, in step S265, if it is determined that all coefficients are processed, the MR pass process is terminated. Then, the procedure returns to step S127 in FIG. 10, and then the processes of step S128 and thereafter are performed.

In the case of the MR pass process, in a similar way to the case of the CU pass or SP pass, the MQ coding is performed regardless of the calculation result of the bit modeling. The EBCOT 105 takes advantage of characteristics of the MQ coding, and thus, it is also unnecessary to perform condition determination in the MR pass process.

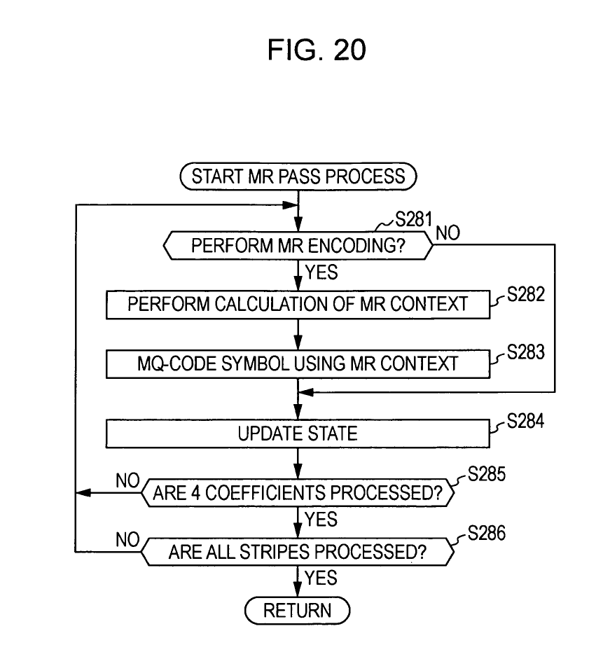

In this respect, a flow of the MR pass process in the related art is shown in a flowchart in FIG. 20.

That is, there exists a conditional branch (step S281) of whether or not to perform the MR coding. This conditional branch is performed for each coefficient of the coefficient group (4 coefficients) in the stripe in the vertical direction. Accordingly, the speed is likely to be significantly reduced due to overhead by the conditional branch.

In this respect, as described above, the EBCOT 105 does not generate conditional branches at all in the processes (steps S261 to S263 in FIG. 19) for each coefficient. Thus, the EBCOT 105 can perform the coding at a high speed, compared with the method in the related art.

As described above, the EBCOT 105 newly defines the transitions of the states of the coefficients in the code block, thereby making it completely unnecessary to perform conditional branches in the coefficient unit which cause a significant problem in the EBCOT coding in the related art, by the process based on the calculation result obtained in advance. Accordingly, the image coding apparatus 100 can perform the coding process at a higher speed.

### 2. Second Embodiment

### Configuration of Image Coding Apparatus

The EBCOT for the plurality of code blocks may be performed in parallel so that the coding process can be performed at a high speed.

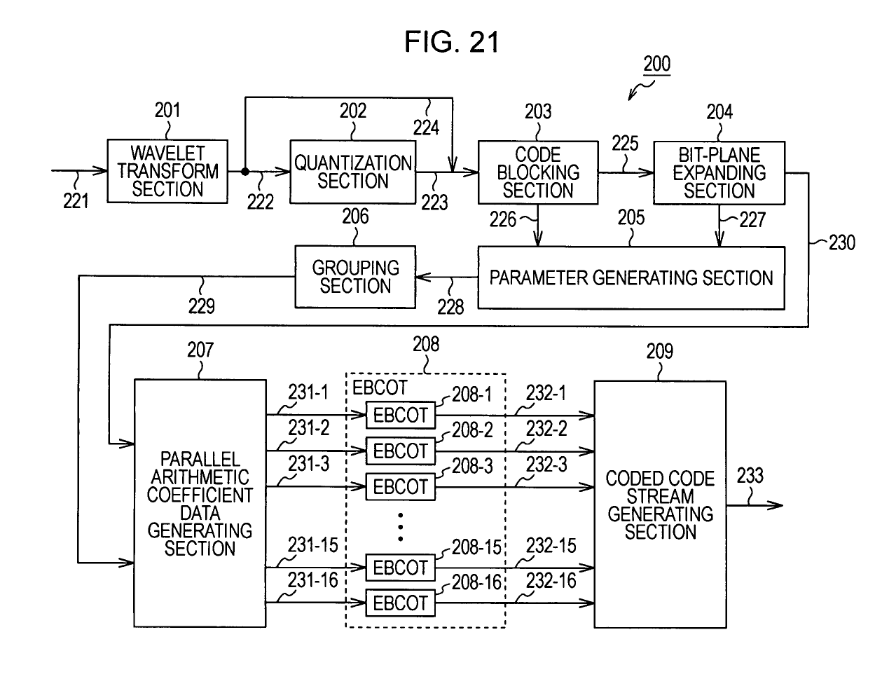

FIG. 21 is a block diagram illustrating another example of a configuration of an image coding apparatus according to an embodiment of the present invention. An image coding apparatus 200 shown in FIG. 21 basically has the same configuration as the image coding apparatus 100 in FIG. 1, but is a coding apparatus which reversibly or irreversibly codes image data according to the JPEG2000 system.

Here, the image coding apparatus 200 performs the EBCOT for the plurality of code blocks in parallel.

In EBCOT in the related art, since after sequential processing is performed, “dependence” occurs in which the result of an upper bit-plane affects the result of a lower bit-plane, it is difficult to parallelize the inside of code blocks. Therefore, in the case of coding and lossless compression for an image having a high level of resolution, how to realize high-speed processing of the calculation load in JPEG2000, in particular, EBCOT, has been a key issue.

Thus, the image coding apparatus 200 appropriately groups the code blocks to generate parallel arithmetic coefficient data, and performs the plurality of EBCOT processes in parallel. Thus, the image coding apparatus 200 can realize high-speed processing of EBCOT, that is, reduction in the calculation load in JPEG2000.

As shown in FIG. 21, the image coding apparatus 200 has basically the same configuration as the image coding apparatus 100 in FIG. 1. That is, the image coding apparatus 200 includes a wavelet transform section 201 which is the same as the wavelet transform section 101 in FIG. 1; a quantization section 202 which is the same as the quantization section 102 in FIG. 1; a code blocking section 203 which is the same as the code blocking section 103 in FIG. 1; and a bit-plane expanding section 204 which is the same as the bit-plane expanding section 104 in FIG. 1.

However, the image coding apparatus 200 has an EBCOT 208 instead of the EBCOT 105 in FIG. 1, and has a coded code stream generating section 209 instead of the coded code stream generating section 106 in FIG. 1.

Further, the image coding apparatus 200 includes a parameter generating section 205, a grouping section 206, and a parallel arithmetic coefficient data generating section 207.

The wavelet transform section 201 filters the input image data (arrow 221), for example, using a 5×3 wavelet transform filter to generate wavelet coefficients. The wavelet transform section 201 supplies the coefficient data (wavelet coefficients) obtained by the filtering for each sub-band to the quantization section 202 (arrow 222).

The quantization section 202 quantizes the supplied coefficient data (wavelet coefficients). The quantization section 202 supplies the obtained coefficient data (quantized coefficients) to the code blocking section 203 (arrow 223). The quantization process is omitted in the case of lossless compression. In this case, the coefficient data (wavelet coefficients) output from the wavelet transform section 201 is supplied to the code blocking section 203 (arrow 224).

The code blocking section 203 divides the supplied coefficient data into rectangular code blocks of a predetermined size, which are processing units of entropy coding. The code blocking section 203 supplies the coefficient data to the bit-plane expanding section 204, for every code block (arrow 225). Further, the code blocking section 203 supplies information about each code block to the parameter generating section 205 (arrow 226).

The bit-plane expanding section 204 expands the supplied coefficient data for every code block into a bit-plane in each bit position. The bit-plane expanding section 204 supplies the parallel arithmetic coefficient data generating section 207 with the expanded bit-planes, in order from the most significant bit (MSB) of the coefficients to the least significant bit (LSB) thereof. That is, the bit-plane expanding section 204 supplies the parallel arithmetic coefficient data generating section 207 with the expanded bit-planes in order from a higher level side to a lower level side of the bit depth (arrow 230). Further, the bit-plane expanding section 204 supplies the parameter generating section 205 with information about the bit-plane expansion (arrow 227).

The parameter generating section 205 generates parameters indicating characteristics of each code block, on the basis of the information supplied from the code blocking section 203 and the bit-plane expanding section 204.

As the parameters, anything indicating the characteristics of the code blocks may be used, which may include, for example, a horizontal size (h_size) of the code block, a vertical size (v_size) of the code block, sub-band types (LL, HL, LH and HH) and the number of coding passes (num_pass) calculated as will be described later. Of course, other parameters may be included.

What code block these parameters correspond to is expressed in an arbitrary method. For example, this may be correlated with identification information (code block number or the like) on code blocks.

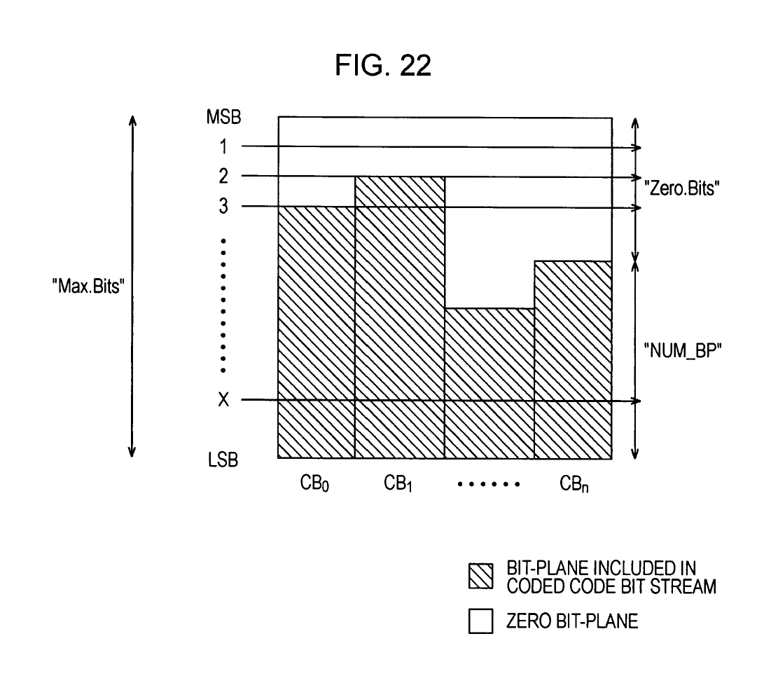

In FIG. 22, the horizontal axis represents code blocks (CB₀ to CBₙ: code blocks of (n+1) items), and the vertical axis represents bit-planes. Bit-planes whose coefficients are all zero and which continue from the bit-plane of the MSB are referred to as zero bit-planes, and other bit-planes are referred to as valid bit-planes. Further, in FIG. 22, “Zero.Bits” represents the number of the zero bit-planes, and “Max.Bits” represents the maximum bit depth (LSB or MSB) defined before coding.

Accordingly, the number of coding passes (num_pass), which indicates the number of coding passes used in one code block, is calculated according to the following formula 1.

num_pass=(Max.Bits−Zero.Bits)×3−2 (1)

Returning to FIG. 21, the parameter generating section 205 supplies the grouping section 206 with the parameters generated as described above (arrow 228).

The grouping section 206 groups the code blocks on the basis of the parameters supplied from the parameter generating section 205. The grouping section 206 obtains parameters for the code blocks corresponding to one picture.

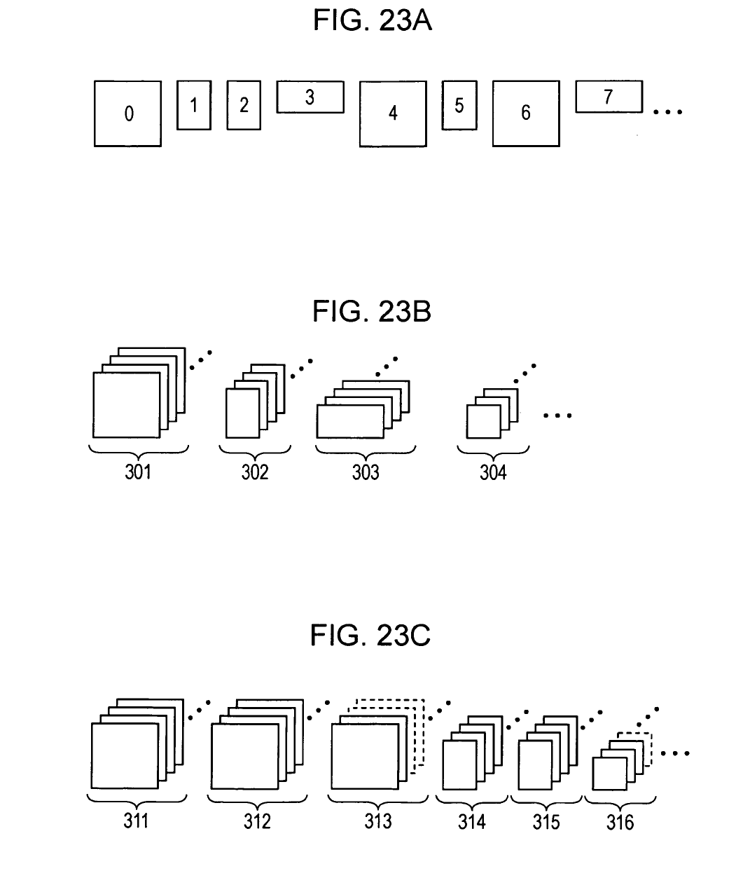

Like an example shown in FIG. 23A, the sizes (horizontal and vertical sizes) of the code blocks in the picture are not all the same. As described above, the code blocking is basically performed to be the same size (basic size), but the basic size may not be secured in opposite ends, upper and lower ends or the like of the image (sub-band). The size of the code blocks in such a portion is smaller than the basic size.

Further, as described above, since the code blocking is performed for the coefficient data, the sub-bands to which each code block in the picture belongs are not all the same. Further, since the numbers of zero bit-planes (the numbers of valid bit-planes) are independent of each other in respective code blocks, the numbers of the coding passes may be different from each other in the respective code blocks.

The grouping section 206 compares parameter values of each code block in the picture, and groups the code blocks in which all values are the same, as shown in FIG. 23B.

In FIG. 23B, group 301 to group 304 are code block groups sorted according to the parameters in this way. In other words, all parameter values of all code blocks are the same in each group.

The grouping section 206 appropriately divides the groups sorted according to the parameters so that each group is formed by 16 code blocks to the maximum. Group 311 to group 316 shown in an example in FIG. 23C are a part of groups obtained by further dividing each groups in FIG. 23B so that the number of the code blocks becomes 16 to the maximum. For example, the groups 311 to 313 in FIG. 23C are obtained by further dividing the group 301 in FIG. 23B, and the groups 314 and 315 in FIG. 23C are obtained by further dividing the group 302 in FIG. 23B. The group 316 in FIG. 23C corresponds to the group 304 in FIG. 23B, but since the number of the code blocks which belongs to the group 304 is 16 or less, the group 316 has the same number of the code blocks as the group 304.

Returning to FIG. 21, the grouping section 206 supplies information about the grouping and information about each code block such as parameters or the like to the parallel arithmetic coefficient data generating section 207 (arrow 229).

The parallel arithmetic coefficient data generating section 207 rearranges the coefficient data of each code block in every group to generate the parallel arithmetic coefficient data, so that the code blocks in the group can be calculated (entropy coding) in parallel.

If the parallel arithmetic coefficient data generating section 207 obtains the coefficient data from the bit-plane expanding section 204, the parallel arithmetic coefficient data generating section 207 stores the coefficient data in a memory (not shown). If the parallel arithmetic coefficient data generating section 207 obtains (stores) the coefficient data corresponding to one picture, the parallel arithmetic coefficient data generating section 207 reads the coefficient data in the same position in each code block which belongs to a process target group, from the top to the bottom and from the left to the right, according to the grouping by the grouping section 206, and arranges the read coefficient data in the register in the memory. The parallel arithmetic coefficient data generating section 207 performs the reading of the coefficient data for each bit-plane.

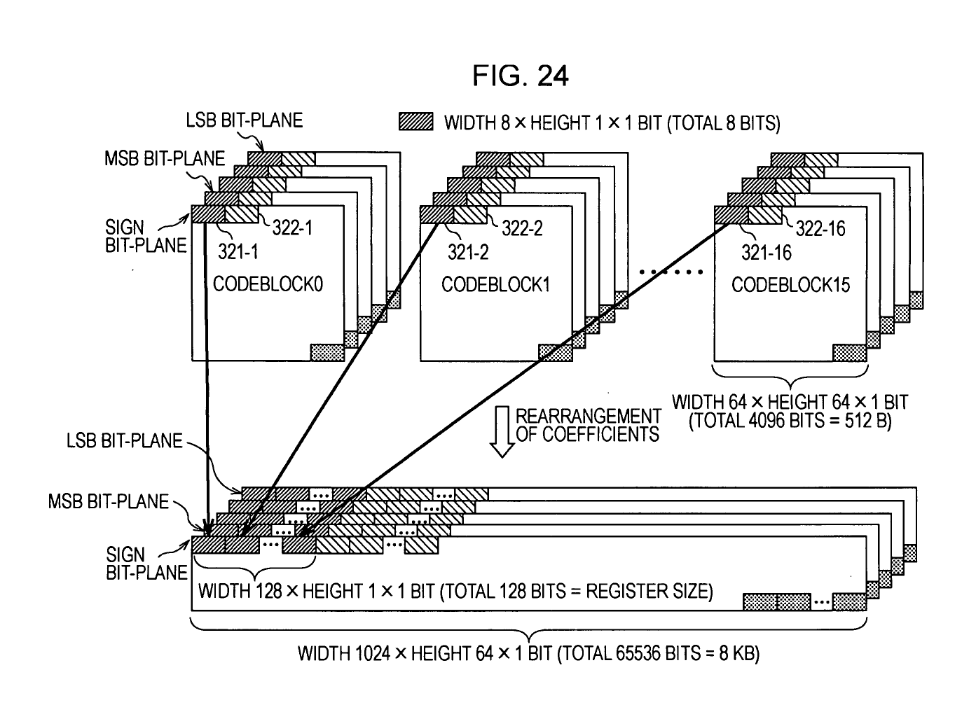

FIG. 24 illustrates an example of generating the parallel arithmetic coefficient data from a group of code blocks of 64×64 in size. A codeblock0 to a codeblock15 in the upper section in FIG. 24 illustrate 16 code blocks which belong to the process target group. In the lower section thereof is shown the coefficient data arranged (rearranged) in the register.

As shown in FIG. 24, the coefficient data located in the same position for each code block is read by 8 bits (width 8× height 1×1 bit) for every bit-plane, which are arranged in the register. For example, in a sign bit-plane, coefficient data 321-1 of 8 bits is read from the codeblock0, and coefficient data 321-2 of 8 bits is read from the codeblock1. Similarly, coefficient data is read from the codeblock3 to the codeblock14, and then coefficient data 321-16 of 8 bits is read from the codeblock15. The coefficient data 321-1 to the coefficient data 321-16 are arranged in the register in parallel. That is, this becomes parallel arithmetic coefficient data of 128 bits (width 128× height 1×1 bit) (the size of the register is 128 bits or more).

As will be described later, if the parallel arithmetic coefficient data in the register is parallelized and coded for every coefficient data of 8 bits, then the next coefficient data 322-1 of 8 bits is read from the codeblock0, the next coefficient data 322-2 of 8 bits is read from the codeblock1. Similarly, the next coefficient data of 8 bits is read from the codeblock3 to the codeblock14, and the next coefficient data 322-16 of 8 bits is read from the codeblock15. The coefficient data 322-1 to 322-16 is arranged in the register in parallel, in a similar way to the coefficient data 321-1 to 321-16. That is, this becomes parallel arithmetic coefficient data of 128 bits (width 128× height 1×1 bit).

The parallel arithmetic coefficient data is also parallelized and coded for every coefficient data of 8 bits. Such a process is performed for all the coefficient data in the code block.

At this time, values of parameters (horizontal size, vertical size, coding pass number (valid bit-plane number) and sub-band type) in the code blocks which belong to the same group are all the same as each other. That is, the numbers of the samples of each of codeblock0 to codeblock15 (64×64=4,096), the numbers of the bit-planes of the MSB or the LSB, or the like are all the same as each other.

That is, each code block in the same group has a data structure in which coding can be performed in the same method. In other words, each code block has the data structure which enables the easiest parallelization.

In addition, since the data structures are the same as each other, the coefficient data of each code block can be easily rearranged by the above-described rearrangement process so that the parallelization is appropriately performed.

In a case where the number of the code blocks in the group is less than 16, the parallel arithmetic coefficient data generating section 207 complements dummy data (for example, zero value) as a countermove (the number of the code blocks becomes 16 in a pseudo manner).

Returning to FIG. 21, the parallel arithmetic coefficient data generating section 207 supplies the parallel arithmetic coefficient data to the EBCOT 208. The EBCOT 208 performs the bit modeling for the coefficient data, and then arithmetically codes the bit-plane of the coefficient.

Here, the EBCOT 208 has an EBCOT 208-1 to an EBCOT 208-16. The EBCOT 208-1 to the EBCOT 208-16 perform the bit modeling for the coefficient data, respectively, and then arithmetically code the bit-plane of the coefficient. That is, the EBCOT 208 performs the entropy coding in a maximum of 16 parallels.

The EBCOT 208-1 to the EBCOT 208-16 have the same configuration as the EBCOT 105 in FIG. 1, and similarly perform the EBCOT, respectively. That is, the EBCOT 208-1 to the EBCOT 208-16 newly defines the transitions of the states of the coefficients in the code block, respectively, thereby making it completely unnecessary to perform conditional branches in the coefficient unit which cause a significant problem in the EBCOT coding in the related art, by the process based on the calculation result obtained in advance. That is, the EBCOT 208-1 to the EBCOT 208-16 can perform the EBCOT at a higher speed, respectively.

The parallel arithmetic coefficient data generating section 207 supplies the parallel arithmetic coefficient data of the register by 8 bits, that is, the coefficient data read from each code block to the EBCOT 208-1 to the EBCOT 208-16, respectively (arrows 231-1 to 231-16).

The EBCOT 208-1 to the EBCOT 208-16 code the supplied coefficient data to generate coded data, in parallel each other.

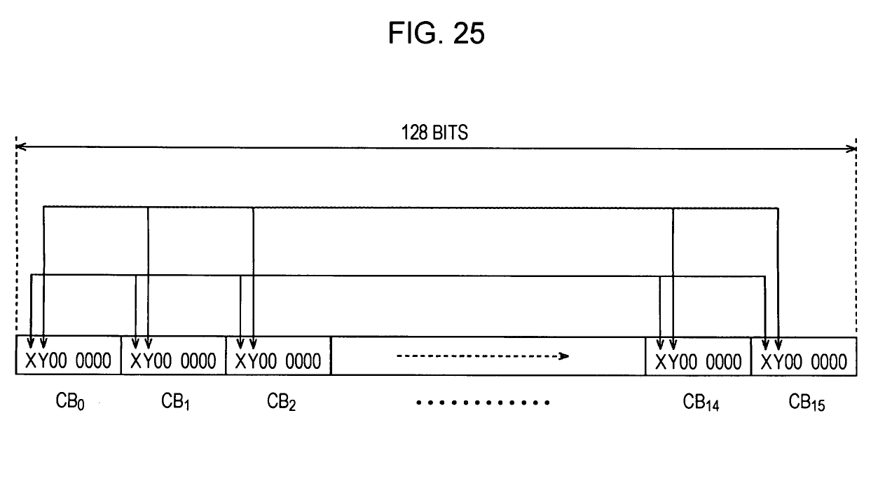

FIG. 25 is a diagram illustrating a state where coefficients in the 128-bit register in FIG. 24 are operated in 16 parallels at a time. In the figure, binary values divided by 8 pixels are processed from the left end to the right end while being shifted by one bit.

In the related art, the coding is performed in the following order.

Step 1: X of CB₀->Y-> . . . 0

Step 2: X of CB₁->Y-> . . . 0

Step 3: X of CB₂->Y-> . . . 0

. . .

Step 15: X of CB₁₄->Y-> . . . 0

Step 16: X of CB₁₅->Y-> . . . 0

Accordingly, as shown in step 1 to step 16, a time corresponding to 16 code blocks×8 bits is taken.

On the other hand, in the present embodiment, the coefficients located in the same positions of 16 code blocks are coded at one time (in parallel).

That is, in the present embodiment, the coding is performed in the following order.

Step 1: X of CB₀, CB₁, CB₂, . . . CB₁₄, CB₁₅

Step 2: Y of CB₀, CB₁, CB₂, . . . CB₁₄, CB₁₅

Step 3: 0 of CB₀, CB₁, CB₂, . . . CB₁₄, CB₁₅

Step 4: 0 of CB₀, CB₁, CB₂, . . . CB₁₄, CB₁₅

Step 5: 0 of CB₀, CB₁, CB₂, . . . CB₁₄, CB₁₅

Step 6: 0 of CB₀, CB₁, CB₂, . . . CB₁₄, CB₁₅

Step 7: 0 of CB₀, CB₁, CB₂, . . . CB₁₄, CB₁₅

Step 8: 0 of CB₀, CB₁, CB₂, . . . CB₁₄, CB₁₅

Accordingly, the EBCOT 208 can code in a time corresponding to 8 bits of step 1 to step 8. That is, the EBCOT 208 can perform the coding at a higher speed, compared with the case in the related art.

As described above, since the EBCOT 208-1 to the EBCOT 208-16 can omit the conditional branch, respectively, the processing time for each parallelized process can be reduced and also the difference between the processing times of the respective processes can be reduced. Thus, the EBCOT 208 also can perform coding at a high speed.

Returning to FIG. 21, the EBCOT 208-1 to the EBCOT 208-16 supply the generated coded data to the coded code stream generating section 209 (arrows 232-1 to 232-16).

The coded code stream generating section 209 rearranges the coded data supplied from the EBCOT 208-1 to the EBCOT 208-16 in the same order as the arrangement of the coded data in the related art, and outputs the rearranged coded data as one code stream (arrow 233).

As described above, in the related art, the respective code blocks of the coefficient data expanded in the bit-plane are sequentially coded. The coded code stream generating section 209 rearranges the order of the respective coded data in the same arrangement order as the coefficient data which is coded and generated in such an order.

The rearrangement of the coded data is performed, for example, by temporarily storing each coded data generated by the EBCOT 208-1 to the EBCOT 208-16 in the memory and by reading the stored coded data in the coding order in the related art.

In a case where the coding is performed after the dummy data is complemented by the parallel arithmetic coefficient data generating section 207, the coded code stream generating section 209 deletes coded data corresponding to the dummy data (which is not included in the code stream).

### [Flow of Process]

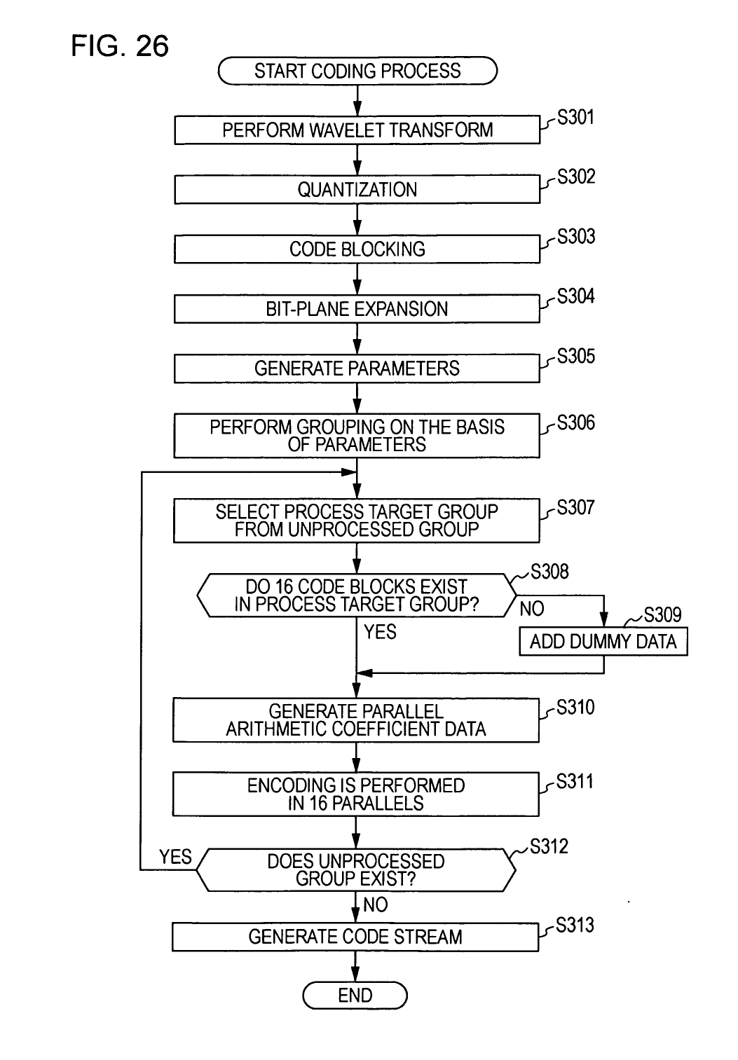

An example of a flow of such a coding process as described above will be described with reference to a flowchart of FIG. 26.

If the coding process starts, in step S301, the wavelet transform section 201 wavelet-transforms image data corresponding to one picture. In step S302, the quantization section 202 quantizes the coefficient data generated in step S301. The process of step S202 is omitted in the case of lossless coding.

In step S303, the code blocking section 203 code-blocks the coefficient data. In step S304, the bit-plane expanding section 204 expands the coefficient data in bit-planes.

In step S305, the parameter generating section 205 generates parameters (for example, h_size, v_size, num_pass and sub_type) of each code block. In step S306, the grouping section 206 groups each code block on the basis of the parameters. As described above, the grouping section 206 collects 16 code blocks to the maximum in which the parameter values are all the same, into one group.

In step S307, the parallel arithmetic coefficient data generating section 207 selects a process target group from unprocessed groups in the respective groups generated in step S306.

In step S308, the parallel arithmetic coefficient data generating section 207 determines whether the 16 code blocks exist in the process target group. If it is determined that the 16 code blocks exist in the process target group, the procedure goes to step S310.

Further, if it is determined in step S308 that the 16 code blocks do not exist in the process target group, the procedure goes to step S309. In step S309, the parallel arithmetic coefficient data generating section 207 adds dummy data of the code block corresponding to the number of the code blocks which is lacking for the 16 items. For example, the parallel arithmetic coefficient data generating section 207 adds the code block in which all coefficient values are zero to the code blocks of the process target group as the dummy data.

Through the process of step S309, if the number of the code blocks of the process target group becomes 16 items including the dummy data, the procedure goes to step S310.

In step S310, the parallel arithmetic coefficient data generating section 207 generates parallel arithmetic coefficient data using the coefficient data of each code block in the process target group. In step S311, the EBCOT 208 performs the entropy coding in 16 parallels using the parallel arithmetic coefficient data.

In step S312, the parallel arithmetic coefficient data generating section 207 determines whether an unprocessed group exists. If it is determined that the unprocessed group exists, the procedure returns to step S307, and then repeats the subsequent processes. Further, if it is determined in step S312 that all the groups in the picture are processed, the procedure goes to step S313.

In step S313, the coded code stream generating section 209 rearranges the coded data generated in the EBCOT 208 to generate a coded stream for output. If the process of step S313 is terminated, the coding process is terminated.

The coding process is performed for every picture.

As described above, the image coding apparatus 200 performs the entropy coding for the plurality of code blocks in parallel, while omitting the conditional branches in the coding, on the basis of the parameters indicating the characteristics of each code block. Thus, the image coding apparatus 200 can more significantly reduce the calculation load of the coding process, and can perform the coding at a higher speed.

### Application Example

In the above description, the length of the register is 128 bits, but the length of the resister may be arbitrary. Further, the parallelization number of the EBCOT is 16, but the present invention is not limited thereto and thus may be arbitrary. Of course, as the parallelization number is increased, the coding process is performed at a higher speed.

In FIG. 21, the EBCOT 208 includes the EBCOT 208-1 to the EBCOT 208-16, but this is a configuration example in a case where the number of performable parallelization processes is 16. That is, the configuration of the EBCOT 208 is determined according to the parallelization number. For example, in a case where the parallelization number is N, the EBCOT 208 includes the EBCOT 208-1 to the EBCOT 208-N.

Here, the parallelization number of the EBCOT depends on the length of the register and a process unit data amount thereof. For example, in a case where the register length is 128 bits and the process unit is 8 bits as described above, the parallelization number becomes 128/8=16. That is, the parallelization number N of the EBCOT can be expressed as a value (N=L/D) obtained by dividing the data register length of L bits of a computer or hardware by the bit length of D bits of the data process unit (N, L and D are natural numbers).

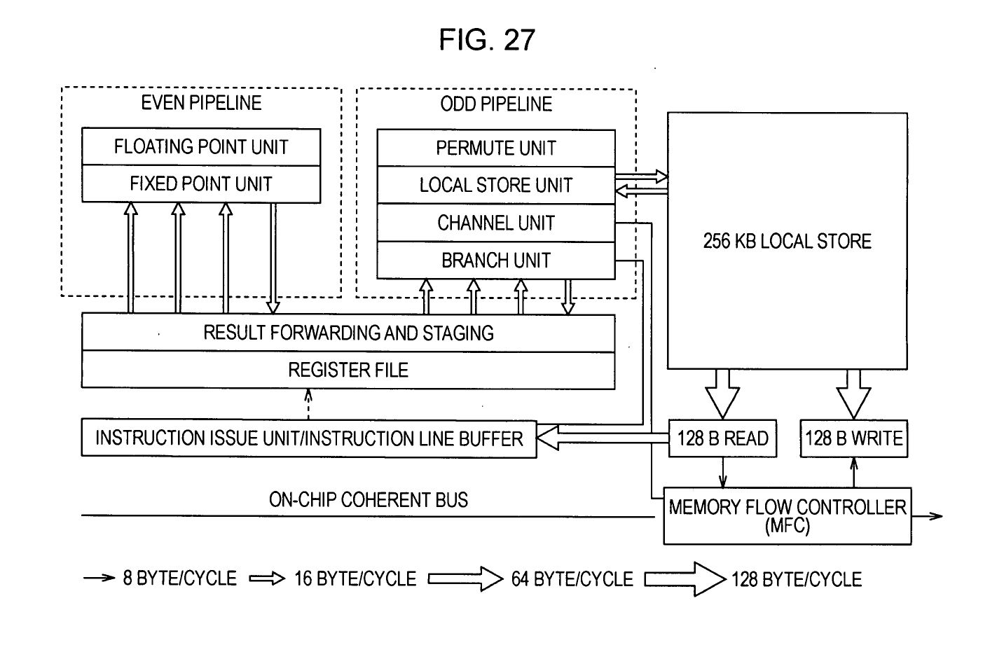

Generally, the length of a data register of a computer or hardware is determined at an initial design stage. That is, the maximum parallelization number of the EBCOT mainly depends on the hardware specification. FIG. 27 is a diagram illustrating a configuration example of hardware to which the image coding apparatus 200 in FIG. 21 is applied.

The configuration shown in FIG. 27 is a configuration of SPE (Synergistic Processing Elements) which has 8 sub-processors existing in a processor referred to as CBE (Cell Broadband Engine). As shown in FIG. 27, the SPE is configured so that reading or writing (Read/Write) inunits of 128 bits is possible for a local storage (cache memory) of 256 KB. That is, this corresponds to the register length of 128 bits.

Further, in the reading or writing (Read/Write) for the 128-bit register, 8 bits×16 parallels, 16 bits×8 parallels, or 32 bits×4 parallels may be used. Accordingly, 16 parallels are the maximum parallelism in the SPE, but for example, in other computer systems or hardware, 4 bits×32 parallels or 2 bits×64 parallels may be used. In this case, the coding process can be performed at a higher speed.

### 3. Third Embodiment

### Personal Computer

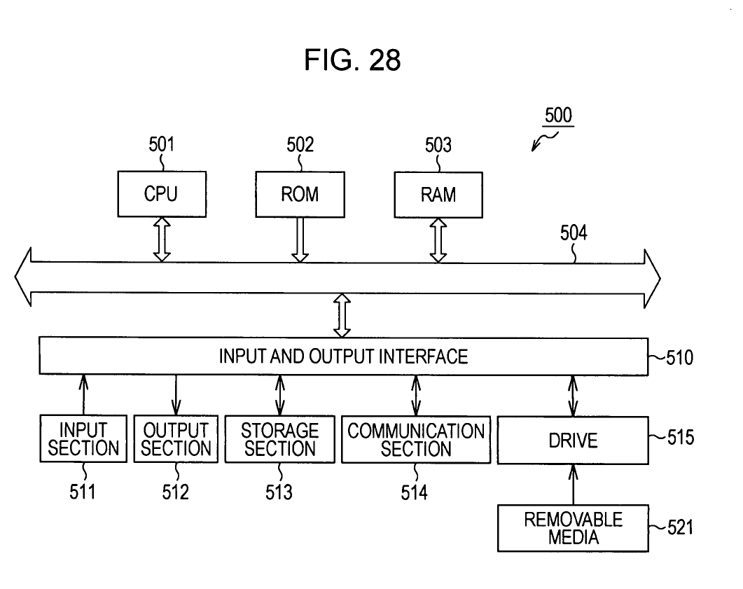

The series of processes as described above can be realized by hardware, or can be realized by software. In this case, a personal computer shown in FIG. 28 can be used by way of example.

In FIG. 28, a CPU (Central Processing Unit) 501 of a personal computer 500 performs a variety of processes according to a program stored in a ROM (Read Only Memory) 502 or a program loaded in a RAM (Random Access Memory) 503 from a storage section 513. In the RAM 503, data or the like which is necessary for the CPU 501 to perform the variety of processes is also appropriately stored.

The CPU 501, the ROM 502 and the RAM 503 are connected to each other through a bus 504. An input and output interface 510 is also connected to the bus 504.

An input section 511 including a keyboard, a mouse or the like; an output section 512 including a display such as a CRT (Cathode Ray Tube) or an LCD (Liquid Crystal Display), a speaker and the like; and a storage section 513 including a hard disc or the like; and a communication section 514 including a modem or the like are connected to the input and output interface 510. The communication section 514 performs a communication process through a network including the Internet.

Further, a drive 515 is connected to the input and output interface 510, and a removable media 521 such as a magnetic disc, optical disc, magneto-optical disc, semiconductor memory or the like are appropriately installed to the input and output interface 510, as necessary. Further, computer programs read from the removable media 521 are installed in the storage section 513 as necessary.

In a case where the above-described series of processes are performed by software, a program for forming the software is installed from a network or a recording medium.

As shown in FIG. 28, this recording medium may be configured by the removable media 521 including a magnetic disc (including a flexible disc), an optical disc (including CD-ROM (Compact Disc-Read Only Memory) and DVD (Digital Versatile Disc)), a magneto-optical disc (including MD (Mini Disc)), a semiconductor memory or the like, in which a program is recorded and which is distributed to a user for delivery of the program being separately provided from a main apparatus body, or may be configured by the ROM 502, a hard disc included in the storage section 513, or the like in which the program is recorded and which is distributed to the user in the state of being assembled in the main apparatus body in advance.

The program executed by the computer may be processed in a time series manner in the order as mentioned in this description, may be processed in parallel, or may be at such a necessary timing that the program is called.

Further, in this description, the step of describing the program which is recorded in the recording medium may include a process which is performed in a time series manner in the described order, or may include a process which is performed in parallel or independently, differently from the time series process.

Further, in this description, the term “system” refers to the entire apparatus including a plurality of devices.

In this respect, the configuration described as a single device (or processing section) may be divided into a plurality of devices (or processing sections). Opposite to this, the configuration described as a plurality of devices (or processing sections) may be integrated into a single device (or processing section). Further, a different configuration may be added to the configuration of each device (or processing section). Further, as long as the configuration or operation of the entire system is substantially the same, a part of a configuration of a specific device (or processing section) may be integrated into a configuration of a different device (or different processing section). That is, the embodiments of the present invention are not limited to the above description, and can be variously modified without departing from the spirit of the invention.

The embodiments of the present invention may be applied, for example, to digital cinema editing apparatuses, archive systems, image transmission apparatuses in broadcasting stations, image databases, medical image recording systems, network servers, non-linear editing apparatuses, game machines, television set systems, HDD recorders, authoring tools on personal computers, software modules thereof, or the like.

The present application contains subject matter related to that disclosed in Japanese Priority Patent Application JP 2009-242769 filed in the Japan Patent Office on Oct. 21, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A coding apparatus comprising:
wavelet transform means for transforming image data into coefficient data for every sub-band;
code blocking means for dividing a region of the sub-band of the coefficient data generated by the wavelet transform means into code blocks;
state transition means for transitioning a state of the coefficient data which is a process target according to the value and state of surrounding binary coefficient data adjacent to the coefficient data which is the process target;
selection means for selecting a coding pass according to the state of the coefficient data transited by the state transition means; and
coding means for coding the coefficient data for every code block generated by the code blocking means according to the coding pass selected by the selection means.

2. The coding apparatus according to claim 1,
wherein the state of the coefficient data is defined by four variables of a positive or negative sign (Sign), a first state variable (Status-0), a second state variable (Status-1) and significance (Sig) of a coefficient.

3. The coding apparatus according to claim 1,
wherein the state of the coefficient data is obtained, on the basis of an information table indicating the correspondence relation between three variables of a first state variable (Status-0), a second state variable (Status-1) and significance (Sig), and seven states of the coefficient data, from values of the three variables.

4. The coding apparatus according to claim 3,
wherein a first state of the seven states is a state where the coefficient data is coded by a CU pass, a second state thereof is a state where the coefficient data becomes an invalid sample, a third state is a state where a surrounding significant sample exists and the coefficient data is coded by the CU pass when the coefficient data is not coded in a current bit-plane, a fourth state is a state where the surrounding significant sample exists and the coefficient data is coded by an SP pass, a fifth state is a state where the coefficient data is significant and is already completely coded in the current bit-plane by the SP pass, a sixth state is a state where the coefficient data is significant and is to be coded by an MR pass and the next MR pass is a first MR pass, and a seventh state is a state where the coefficient data is significant and is to be coded by the MR pass and the next MR pass is a second MR pass.

5. The coding apparatus according to claim 4,
wherein the state transition means transits the state of the coefficient data into the third state, in a case where the state of the coefficient data which is the process target is the first state and any one of the surrounding coefficient data become significant through the CU pass.

6. The coding apparatus according to claim 4,
wherein the state transition means transits the state of the coefficient data into the fifth state, in a case where the coefficient data which is the process target is in the first state and become significant through the CU pass.

7. The coding apparatus according to claim 4,
wherein the state transition means transits the state of the coefficient data into the fourth state, in a case where the coefficient data which is the process target is in the third state and is coded by the SP pass.

8. The coding apparatus according to claim 4,
wherein the state transition means transits the state of the coefficient data into the fifth state, in a case where the coefficient data which is the process target is in the third state and become significant through the CU pass.

9. The coding apparatus according to claim 4,
wherein the state transition means transits the state of the coefficient data into the sixth state, in a case where the coefficient data which is the process target is in the fifth state and the coding in one bit-plane is entirely terminated.

10. The coding apparatus according to claim 4,
wherein the state transition means transits the state of the coefficient data into the seventh state, in a case where the coefficient data which is the process target is in the sixth state and the coding in one bit-plane is entirely terminated.

11. The coding apparatus according to claim 1, further comprising storage means for storing the state of each piece of coefficient data in a code block which is a process target, which is transited by the state transition means,
wherein the selection means selects the coding pass according to the state of the coefficient data stored in the storage means.

12. The coding apparatus according to claim 1,
wherein the coding means includes:
calculation means for performing a predetermined calculation for the coefficient data according to the coding pass selected by the selection means; and
arithmetic coding means for performing an arithmetic coding using a calculation result from the calculation means.

13. The coding apparatus according to claim 12,
wherein the calculation means includes:
CU pass calculation means for performing a predetermined calculation for the coefficient data in a case where the CU pass is selected by the selection means;
SP pass calculation means for performing a predetermined calculation for the coefficient data in a case where the SP pass is selected by the selection means; and
MR pass calculation means for performing a predetermined calculation for the coefficient data in a case where the MR pass is selected by the selection means.

14. The coding apparatus according to claim 13,
wherein the CU pass calculation means performs both of a calculation in which a result of a run length coding is zero and a calculation in which the result of the run length coding is one, for four pieces of coefficient data in the code block, and
wherein the arithmetic coding means MQ-codes the coefficient data of a value zero and the coefficient data of a value one, using a context of the run length coding.

15. The coding apparatus according to claim 13,
wherein the CU pass calculation means performs a uniform coding two times, for four pieces of coefficient data in the code block, and
wherein the arithmetic coding means MQ-codes a coefficient zero or one for each of the two-time uniform codings, using a uniform context.

16. The coding apparatus according to claim 13,
wherein the CU pass calculation means calculates whether or not to perform a CU coding for every coefficient data of the code block, and
wherein the arithmetic coding means performs an MQ coding according to a result of the calculation, using a significance context.

17. The coding apparatus according to claim 13,
wherein the CU pass calculation means calculates whether or not to perform a sign coding for every coefficient data of the code block, and
wherein the arithmetic coding means performs an MQ coding according to a result of the calculation, using a sign context.

18. The coding apparatus according to claim 13,
wherein the SP pass calculation means calculates whether or not a value of the coefficient data is one, and
wherein the arithmetic coding means performs an MQ coding according to a result of the calculation, using a sign context.

19. The coding apparatus according to claim 13,
wherein the MR pass calculation means calculates whether or not to perform an MR coding, and
wherein the arithmetic coding means performs an MQ coding according to a result of the calculation, using an MR context.

20. A coding method comprising the steps of:
transforming image data into coefficient data for every sub-band;
dividing a region of the sub-band of the transformed coefficient data into code blocks;
transitioning a state of the coefficient data which is a process target according to a value and a state of surrounding binary coefficient data adjacent to the coefficient data which is the process target, for each divided code block;
selecting a coding pass according to the transited state of the coefficient data; and
coding the coefficient data for each generated code block according to the selected coding pass.

21. A coding apparatus comprising:
a wavelet transform section which transforms image data into coefficient data for every sub-band;
a code blocking section which divides a region of the sub-band of the coefficient data generated by the wavelet transform section into code blocks;
a state transition section which transits a state of the coefficient data which is a process target according to the value and state of surrounding binary coefficient data adjacent to the coefficient data which is the process target;
a selection section which selects a coding pass according to the state of the coefficient data transited by the state transition section; and
a coding section which codes the coefficient data for every code block generated by the code blocking section according to the coding pass selected by the selection section.
